(19) United States
(12) Patent Application Publication
(10) Pub. No.: US 2021/0350373 A1
(43) Pub. Date: Nov. 11, 2021

(54) CRYPTOCURRENCY PAYMENT SYSTEM

(71) Applicant: Flexa Network Inc., New York, NY (US)

(72) Inventors: Tyler Robert Spalding, New York, NY (US); Trevor Filter, New York, NY (US); Zachary Kilgore, Brooklyn, NY (US); David S. McGregor, Brooklyn, NY (US); Christopher M. Pick, Brooklyn, NY (US)

(73) Assignee: Flexa Network Inc., New York, NY (US)

(21) Appl. No.: 16/867,764

(22) Filed: May 6, 2020

(51) Int. Cl. G06Q 20/40; G06Q 20/38; G06Q 20/06

(52) U.S. Cl. CPC G06Q 20/4014; G06Q 20/0655; G06Q 20/381; G06Q 20/382

(57) ABSTRACT

A method for execution by a network computing device of a cryptocurrency payment system includes receiving real-time payment information regarding a cryptocurrency-based payment from a source computing device to a destination computing device. In response to receiving the real-time payment information, the method further includes: initiating a real-time cryptocurrency-based payment process to pay the destination computing device in a selected currency, where payment of the selected currency to the destination computing device occurs within a first time frame; and initiating a nonreal-time cryptocurrency-based payment reconciliation process to reconcile the cryptocurrency-based payment with a cryptocurrency-based payment backing account, where the reconciliation of the cryptocurrency-based payment with the cryptocurrency-based payment backing account occurs within a second time frame, and where the second time frame is longer than the first time frame.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to electronic payments and more particularly to a universal digital payment system including cryptocurrency.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity has its own varying security problems (e.g., hacking).

The steps involved are also inconvenient, time consuming, and expensive. For example, payment card authorization (e.g., credit or debit card authorization) begins with the cardholder presenting the payment card to a merchant for goods or service. The payment card is issued by a particular financial institution (e.g., a bank) and is associated with a payment card company (e.g., Visa, Mastercard, etc.). The merchant uses a payment card machine, software, or gateway to transmit transaction data to their acquiring bank (or its processor). The acquiring bank routes the transaction data to a payment processing network and the payment processing network sends the transaction data to the cardholder's issuing bank. The issuing bank validates that the card has not been reported stolen or lost, confirms whether funds are available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. The response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees and those costs are passed along to consumers. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Mobile wallet applications allow cardholders to store payment card data on a computing device via a digital wallet for convenient transactions. For example, some mobile wallet apps use near field communication (NFC) for contactless payments (e.g., exchange of data by holding device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment. Further, user fraud via mobile wallets is possible.

Distributed ledger technology (e.g., a blockchain) reduces the risk of fraudulent activity. For example, a blockchain is an immutable ledger for recording transactions within a network, consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the entire network. Once recorded on the blockchain, transactions cannot be altered.

A cryptocurrency is a digital asset that is securely created and transferred via cryptography. Many cryptocurrencies are distributed networks based on distributed ledger technology (e.g., a blockchain). Decentralized networks like Bitcoin use pseudo-anonymous transactions that are open and public (i.e., anyone can join, create, and view transactions). To minimize fraudulent activity and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

### BRIEF DESCRIPTION OF THE SEVERAL VIEWS OF THE DRAWING(S)

FIG. 1 is a schematic block diagram of an embodiment of a cryptocurrency payment system in accordance with the present invention;

FIG. 2 is a flowchart of an example of a method for execution by a network computing device of the cryptocurrency payment system in accordance with the present invention;

FIG. 3 is a schematic block diagram of another embodiment of a cryptocurrency payment system in accordance with the present invention;

FIG. 4 is a flowchart of an example of a method for execution by a network computing device of the cryptocurrency payment system in accordance with the present invention;

FIG. 5 is a schematic block diagram of another embodiment of a cryptocurrency payment system in accordance with the present invention;

FIG. 6 is a flowchart of an example of a method for execution by a network computing device of the cryptocurrency payment system in accordance with the present invention;

FIG. 7 is a schematic block diagram of another embodiment of a cryptocurrency payment system in accordance with the present invention;

FIGS. 8A-8E are schematic block diagrams of examples of a cryptocurrency-based payment backing account device in accordance with the present invention;

FIG. 9 is a flowchart of an example of a method for execution by a cryptocurrency-based payment backing account device in accordance with the present invention;

FIG. 10 is a schematic block diagram of an existing payment network;

FIG. 11 is a schematic block diagram of another embodiment of a cryptocurrency payment system in accordance with the present invention;

FIG. 12 is a schematic block diagram of another embodiment of a cryptocurrency payment system in accordance with the present invention;

FIG. 13 is a schematic block diagram of another embodiment of a cryptocurrency payment system in accordance with the present invention;

FIG. 14 is a schematic block diagram of another embodiment of a cryptocurrency payment system in accordance with the present invention;

FIG. 15 is a schematic block diagram of another embodiment of a cryptocurrency payment system in accordance with the present invention;

FIG. 16 is a schematic block diagram of another embodiment of a cryptocurrency payment system in accordance with the present invention;

FIG. 17 is a schematic block diagram of another embodiment of a cryptocurrency payment system in accordance with the present invention;

FIG. 18 is a schematic block diagram of another embodiment of a cryptocurrency payment system in accordance with the present invention;

FIG. 19 is a schematic block diagram of another embodiment of a cryptocurrency payment system in accordance with the present invention; and

FIG. 20 is a flowchart of an example of a method of processing a cryptocurrency-based payment from a consumer computing device to a merchant computing device in accordance with the present invention.

### DETAILED DESCRIPTION OF THE INVENTION

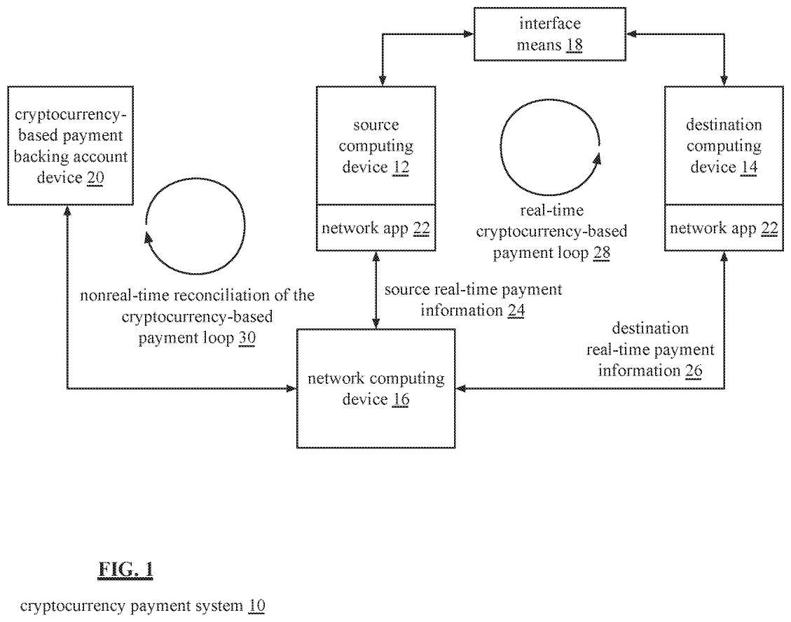

FIG. 1 is a schematic block diagram of an embodiment of a cryptocurrency payment system 10 that includes a source computing device 12, a destination computing device 14, a network computing device 16, an interface means 18, and a cryptocurrency-based payment backing account device 20. The cryptocurrency payment system 10 facilitates a payment from the source computing device 12 paying with a cryptocurrency to a destination computing device 14 accepting a desired currency (e.g., fiat currency, a different cryptocurrency) and overcomes the following issues.

At the filing of this application, cryptocurrency is not widely accepted by merchants as a form of payment for a variety of reasons. For one, many merchants do not want to hold cryptocurrency. Holding cryptocurrency involves several issues merchants are unfamiliar with and/or unequipped to deal with. These issues include holding private key information, legal compliance, government regulation, timing issues such as waiting for transaction confirmations, etc. As another reason, the value of cryptocurrency can be volatile, sometimes fluctuating dramatically in the course of one day. As another reason, merchants are reluctant to invest in expensive point-of-sale upgrades to accommodate cryptocurrency payments directly. As yet another reason, many cryptocurrency payments are public and expose sensitive merchant/customer information.

While some digital wallet applications enable retail blockchain payments, they are universally dependent on existing payment networks and thus are susceptible to the fraud attacks of the existing payment networks. For example, a cryptocurrency is linked to a payment card (e.g., a credit card, debit card, gift card, etc.), where a cryptocurrency payment is converted and conducted as a payment card transaction and, thus susceptible to the same fraud attacks as the payment card.

Even though cryptocurrencies significantly reduce fraudulent activity as compared to traditional payment systems, fraudulent cryptocurrency transactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a cryptocurrency transaction from being authorized and completed correctly.

Within the cryptocurrency payment system 10, the source computing device 12, the destination computing device 14, the network computing device 16, and the cryptocurrency-based payment backing account device 20 may be portable computing devices and/or a fixed computing devices. A portable computing device may be a social networking device, a gaming device, a cell phone, a smart phone, a digital assistant, a digital music player, a digital video player, a laptop computer, a handheld computer, a tablet, a video game controller, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., cash register), and/or any type of home or office computing equipment.

In this example, the source computing device 12 and the destination computing device 14 include a network application (“app”) 22 that associates the respective devices to the network computing device 16. For example, the source computing device 12 is a smart phone and the network application 22 is a digital wallet application associated with the network computing device 16 downloaded on the smart phone. As another example, the destination computing device 14 is a POS device and the network application is software associated with the network computing device 16 installed in the POS device.

The cryptocurrency-based payment backing account device 20 stores system cryptocurrency as collateral to back cryptocurrency-based payments of the cryptocurrency payment system 10. The system cryptocurrency is any cryptocurrency the cryptocurrency payment system chooses to use. For example, the system cryptocurrency is a cryptocurrency (e.g., a token on the Ethereum blockchain) specifically created for use in the system. As another example, the system cryptocurrency is an already established and trusted cryptocurrency.

The cryptocurrency-based payment backing account device 20 is associated with one or more of the source computing device 12, the destination computing device 14, and a type of cryptocurrency. Most commonly, the cryptocurrency-based payment backing account device 20 is associated with the source computing device 12. As an example, the cryptocurrency-based payment backing account device 20 is associated with a cryptocurrency wallet of the source computing device 12.

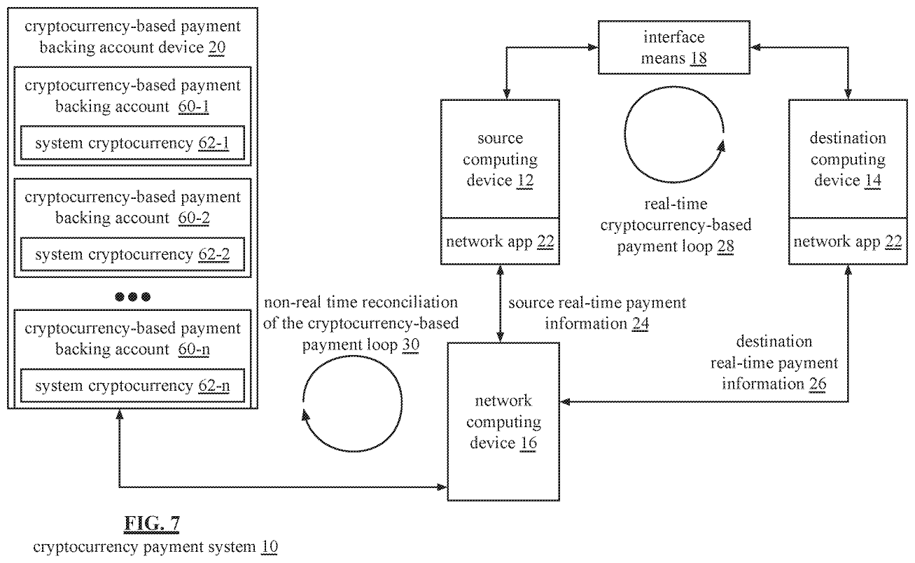

The developer of the cryptocurrency wallet sets up an account with the cryptocurrency-based payment backing account device 20 and deposits system cryptocurrency into its account to back cryptocurrency-based payments made by users of the cryptocurrency wallet. The developer of the cryptocurrency wallet is incentivized to back its wallet users' transactions by receiving rewards from the cryptocurrency-based payment backing account device 20 such as a percentage of system cryptocurrency back on all successful wallet transactions. Further, because the developer is backing wallet user payments, the developer is incentivized to produce a quality digital wallet that prevents user fraud and to remedy faulty software that affects user transaction success. Different types of cryptocurrency-based payment backing accounts of a cryptocurrency-based payment backing account device 20 will be discussed in further detail with reference to FIGS. 7-9.

The source computing device 12 and the destination computing device 14 interact via the interface means 18. The interface means 18 is one or more of: a direct link and a network connection. The direct link includes one or more of video, camera, infrared (IR), radio frequency (RF), barcode scanner, and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the source computing device 12 is a smart phone, the destination computing device 14 is a fixed merchant POS device (e.g., a POS register) and the interface means 18 is the fixed merchant POS device's NFC barcode scanner. The smart phone is operable to generate a code and display the code to the fixed merchant POS device, where the fixed merchant POS device's NFC barcode scanner is operable to read the code.

As another example, the source computing device 12 is a smart phone, the destination computing device 14 is a fixed merchant POS device (e.g., a POS register) and the interface means 18 is the smart phone's camera. The smart phone is operable to read a barcode generated by the fixed merchant POS device via the smart phone's camera.

As another example, the source computing device 12 is a smart phone, the destination computing device 14 is an e-commerce platform, and the interface means 18 is a network connection. For example, a smart phone uses an internet browser application (via cellular or wireless internet connection) to access the e-commerce platform.

As another example, the source computing device 12 is a smart phone, the destination computing device 14 is a smart phone, and the interface means 18 is a Bluetooth network. For example, the two smart phones connect using Bluetooth in order to send a payment from one smart phone to another.

As yet another example, a combination of interface means 18 is possible. For example, a source computing device 12 is a smart phone and the destination computing device 14 is an online POS connection device (e.g., an e-commerce website). A user of the source computing device 12 accesses the e-commerce platform via a network connection interface means 18 on another computing device associated with the user of the source computing device 12 (e.g., a laptop or desktop computer). The laptop or desktop computer displays information for use in a direct link with the smart phone. For example, a code is generated by the e-commerce platform and displayed on the laptop's display. The smart phone's camera scans the code to further interact with e-commerce platform (e.g., complete a payment).

The network computing device 16 is or is associated with a specially licensed entity operable to convert cryptocurrency to a desired currency (e.g., fiat currency, another cryptocurrency, etc.). In an embodiment, the network computing device 16 is associated with one or more cryptocurrency holding companies that are specially licensed to store sensitive materials and have insurance policies to protect against theft and fraud.

The network computing device 16 may be associated with a stored value account (SVA) device where the SVA device is associated with the destination computing device 14 (e.g., the destination computing device has an SVA account with the SVA device) such that an SVA is generated for payment. In another embodiment, the network computing device 16 is operable to generate stored value accounts (SVAs). Generation of SVAs for transactions is described in co-pending patent application Ser. No. 16/376,911, entitled, “SECURE AND TRUSTED DATA COMMUNICATION SYSTEM,” filed Apr. 5, 2019.

In an example of operation, the source computing device 12 and the destination computing device 14 interact via the interface means 18. For example, the source computing device 12 establishes a direct communication link with the destination computing device 14 via an NFC interface means 18.

The source computing device 12 sends source real-time payment information 24 to the network computing device 16 via its network application 22 and the destination computing device 14 sends destination real-time payment information 26 to the network computing device 16 its network application 22. The source real-time payment information 24 includes a source identifier (ID) and a type of cryptocurrency it wishes to use in a real-time payment to the destination computing device 14. The destination real-time payment information 26 includes a destination identifier (ID) and a type of desired currency (e.g., a fiat currency, a different cryptocurrency, etc.) it wishes to receive in the real-time payment from the source computing device 12. One or more of the source real-time payment information 24 and the destination real-time payment information 26 includes the amount of the real-time payment.

When the network computing device 16 receives the source and destination real-time payment information, the network computing device initiates 1) a real-time cryptocurrency-based payment process (e.g., the real-time cryptocurrency-based payment loop 28) and 2) a nonreal-time reconciliation process to reconcile the cryptocurrency-based payment with the cryptocurrency-based payment backing account device 20 (e.g., the nonreal-time reconciliation of the cryptocurrency-based payment loop 30). The reconciliation of the cryptocurrency-based payment with the cryptocurrency-based payment backing account device 20 occurs within a time frame that is longer than the time frame of the real-time cryptocurrency-based payment. For example, the reconciliation of the cryptocurrency-based payment with the cryptocurrency-based payment backing account device 20 occurs over the course of minutes whereas the time frame of the real-time cryptocurrency-based payment takes a few seconds.

Within the nonreal-time reconciliation of the cryptocurrency-based payment loop 30, when the source and destination real-time payment information is received, the network computing device 16 instructs the cryptocurrency-based payment backing account device 20 to lock an amount of system cryptocurrency associated with the real-time cryptocurrency-based payment. Locking the amount of system cryptocurrency associated with the real-time cryptocurrency-based payment is discussed in more detail with reference to FIGS. 7-9.

Within the real-time cryptocurrency-based payment loop 28, when the network computing device 16 receives an amount of cryptocurrency from the source computing device 12 to use in the real-time cryptocurrency-based payment, a network acknowledgment (ACK) of the receipt of the amount of the cryptocurrency is generated. If the payment initiation is terminated (e.g., payment initiation fails and/or is cancelled by the source and/or the destination computing device) within a certain amount of time prior to the network computing device 16 continuing with the following steps of the real-time cryptocurrency-based payment loop 28 (e.g., paying the destination computing device), the ACK is not generated, and the real-time payment is terminated. Within the nonreal-time reconciliation of the cryptocurrency-based payment loop 30, when the ACK is not generated, the network computing device 16 instructs the cryptocurrency-based payment backing account device 20 to release the amount of locked system cryptocurrency.

Sending the amount of cryptocurrency to the network computing device 16 is a transaction added to the cryptocurrency blockchain of the cryptocurrency used by the source computing device 12 (e.g., this information is published). However, other details related to the transaction (e.g., the identity of the destination computing device 14, transaction fees owed by the destination computing device 14, etc.) are managed privately by the network computing device 16 off-chain. Therefore, the cryptocurrency payment system 10 keeps confidential destination computing device 14 related information (e.g., revenue, consumer spending behavior, etc.) and confidential source computing device 12 related information (e.g., consumer identity of purchases, amount spent at a particular merchant, payees/merchants frequented, etc.) private (i.e., not published on the blockchain for anyone to see).

Continuing with the real-time cryptocurrency-based payment loop 28, when the ACK is generated, the network computing device 16 exchanges the amount of the cryptocurrency received from the source computing device 12 to an amount of the desired currency. Cryptocurrency exchange is done quickly (e.g., 30 seconds to a few minutes) to account for exchange rate volatility. The exchange can also be performed in real time on a credit-based account to eliminate any pricing volatility. The network computing device 16 sends the amount of the desired currency to the destination computing device 14 to complete the real-time cryptocurrency-based payment.

Continuing with the nonreal-time reconciliation of the cryptocurrency-based payment loop 30, the network computing device 16 verifies the amount of the cryptocurrency received from the source computing device 12. For example, the network computing device 16 connects to a consensus network that verifies the amount of the cryptocurrency received from the source computing device 12. The consensus network implements a verification process that may take minutes to hours of time.

For example, in the Bitcoin blockchain, miners record new transactions into blocks that verify all previous transactions within the blockchain. On average, it takes a miner ten minutes to write a block on the Bitcoin blockchain and the average block time depends on a total hash power of the Bitcoin network. Once a block is created and a new transaction is verified and included in a block, the transaction will have one confirmation. Each subsequent block (which verifies the previous state of the blockchain) provides one additional network confirmation. Typically, between 5-10 transaction confirmations (depending on the monetary value of the transaction) are acceptable for cryptocurrency exchanges to avoid losses due to potential fraud. Therefore, if the source computing device 12 is using Bitcoin, the network computing device 16 seeks a desired number of confirmations of the amount of the cryptocurrency received by the source computing device from the consensus network 16 (e.g., via Bitcoin miners). As such, the transaction may not be verified by the network computing device for an hour or more. As such, the nonreal-time reconciliation of the cryptocurrency-based payment loop 30 takes longer than the real-time cryptocurrency-based payment loop 28.

When the network computing device 16 verifies the amount of the cryptocurrency received by the source computing device 12, the network computing device 16 instructs the cryptocurrency-based payment backing account device 20 to release the amount of system cryptocurrency associated with the real-time cryptocurrency-based payment. When the network computing device 16 does not verify the amount of the cryptocurrency received by the source computing device 12, the network computing device 16 instructs the cryptocurrency-based payment backing account device 20 to consume the amount of system cryptocurrency associated with the real-time cryptocurrency-based payment.

For example, if fraudulent activity occurs (e.g., the source computing device acts maliciously to spend at two destination computing devices simultaneously, software of the network application 22 is corrupted, etc.) the network computing device 16 consumes the amount of system cryptocurrency associated with the real-time cryptocurrency-based payment. As a specific example, if the source computing device 12 attempts to double spend a transaction, the verification (e.g., the desired number of confirmations in a Bitcoin blockchain example) will not be received and the network computing device 16 will not be able to verify the amount of the cryptocurrency received by the source computing device 12. If the verification is not received, the network computing device 16 withdraws (e.g., consumes) the amount of system cryptocurrency locked by the cryptocurrency-based payment backing account device 20 to cover the real-time payment that occurred with the destination computing device 14.

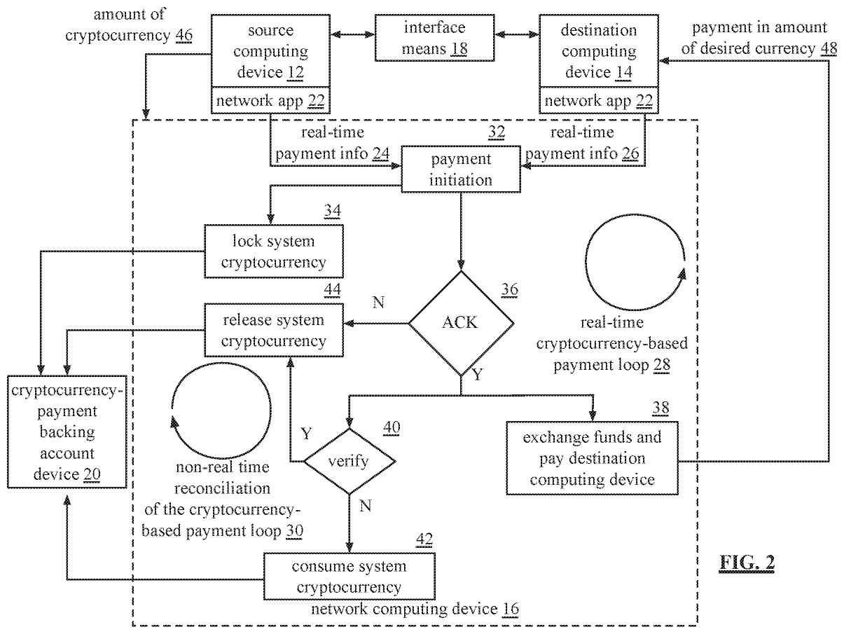

FIG. 2 is a flowchart of an example of a method for execution by a network computing device 16 of the cryptocurrency payment system 10 of FIG. 1. FIG. 2 includes a source computing device 12, a destination computing device 14, a network computing device 16, an interface means 18, and a cryptocurrency-based payment backing account device 20. In this example, the source computing device 12 and the destination computing device 14 include a network application (“app”) 22 that associates the respective devices to the network computing device 16.

The cryptocurrency-based payment backing account device 20 stores system cryptocurrency as collateral to back real-time cryptocurrency-based payments of the cryptocurrency payment system 10. Different types of cryptocurrency-based accounts of a cryptocurrency-based payment backing account device 20 will be discussed in further detail with reference to FIGS. 7-9. The source computing device 12 and the destination computing device 14 interact via the interface means 18. The interface means 18 is one or more of: a direct link and a network connection.

The method begins with step 32 where the network computing device 16 receives real-time payment information regarding a cryptocurrency-based payment from a source computing device 12 to a destination computing device 14. For example, the source computing device 12 sends source real-time payment information 24 to the network computing device 16 via its network application 22 and the destination computing device 14 sends destination real-time payment information 26 to the network computing device 16 its network application 22.

The source real-time payment information 24 includes a source identifier (ID) and a type of cryptocurrency it wishes to use in a real-time payment to the destination computing device 14. The destination real-time payment information 26 includes a destination identifier (ID) and a type of desired/selected currency (e.g., a fiat currency, another cryptocurrency) it wishes to receive in the real-time payment from the source computing device 12. One or more of the source real-time payment information 24 and the destination real-time payment information 26 includes the amount of the real-time payment.

When the network computing device 16 receives the real-time payment information, the network computing device initiates 1) a real-time cryptocurrency-based payment process (e.g., the real-time cryptocurrency-based payment loop 28) and 2) a nonreal-time reconciliation process to reconcile the cryptocurrency-based payment with the cryptocurrency-based payment backing account device 20 (e.g., the nonreal-time reconciliation of the cryptocurrency-based payment loop 30) (i.e., “payment initiation”). The reconciliation of the cryptocurrency-based payment with the cryptocurrency-based payment backing account device 20 occurs within a time frame that is longer than the time frame of the real-time cryptocurrency-based payment.

The method continues with step 34 where, within the nonreal-time reconciliation of the cryptocurrency-based payment loop 30, the network computing device 16 instructs the cryptocurrency-based payment backing account device 20 to lock an amount of system cryptocurrency associated with the real-time cryptocurrency-based payment.

The method continues with step 36 where a network acknowledgment (ACK) of the receipt of the amount of the cryptocurrency is or is not generated. For example, when the network computing device 16 receives an amount of cryptocurrency 46 from the source computing device 12 to use in the real-time cryptocurrency-based payment, the ACK is generated and the method continues to steps 38 and 40. If the payment initiation is terminated (e.g., payment initiation fails and/or is cancelled by the source and/or the destination computing device) within a certain amount of time prior to the network computing device 16 continuing with the following steps of the real-time cryptocurrency-based payment loop 28, the ACK is not generated, and the real-time payment terminates. Within the nonreal-time reconciliation of the cryptocurrency-based payment loop 30, when the ACK is not generated, the method continues with step 44 where the network computing device 16 instructs the cryptocurrency-based payment backing account device 20 to release the amount of locked system cryptocurrency.

Within the real-time cryptocurrency-based payment loop 28, when the ACK is generated, the method continues with step 38 where the network computing device 16 exchanges the amount of the cryptocurrency 46 received from the source computing device 12 to an amount of the desired currency. Cryptocurrency exchange is done quickly (e.g., 30 seconds to a few minutes) to account for exchange rate volatility. The network computing device 16 sends the payment in the amount of the desired currency 48 to the destination computing device 14 to complete the real-time cryptocurrency-based payment.

Within the nonreal-time reconciliation of the cryptocurrency-based payment loop 30, when the ACK is generated at step 36, the method continues with step 40 where the network computing device 16 verifies the amount of the cryptocurrency 46 received from the source computing device 12. For example, the network computing device 16 connects to a consensus network that verifies the amount of the cryptocurrency received from the source computing device 12. For example, the network computing device 16 connects to a consensus network that verifies the amount of the cryptocurrency received from the source computing device 12. The consensus network implements a verification process that may take minutes to hours of time.

When the network computing device 16 verifies the amount of the cryptocurrency received by the source computing device 12 at step 40, the method continues to step 44 where the network computing device 16 instructs the cryptocurrency-based payment backing account device 20 to release the amount of system cryptocurrency associated with the real-time cryptocurrency-based payment. When the network computing device 16 does not verify the amount of the cryptocurrency received by the source computing device 12 at step 40, the method continues to step 42 where the network computing device 16 instructs the cryptocurrency-based payment backing account device 20 to consume the amount of system cryptocurrency associated with the real-time cryptocurrency-based payment.

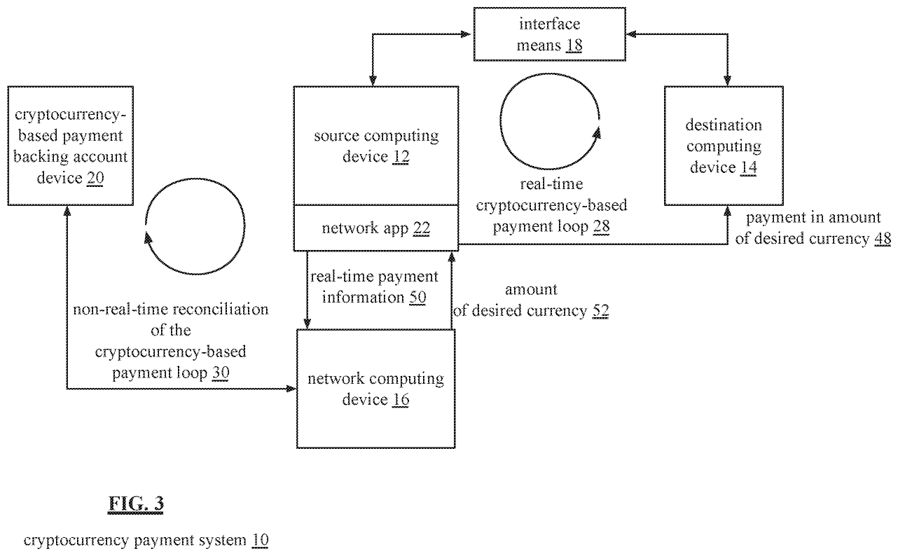

FIG. 3 is a schematic block diagram of another embodiment of a cryptocurrency payment system 10 that includes a source computing device 12, a destination computing device 14, a network computing device 16, an interface means 18, and a cryptocurrency-based payment backing account device 20. The cryptocurrency payment system 10 of FIG. 3 operates similarly to the cryptocurrency payment system 10 of FIG. 1 except that the destination computing device 14 does not include a network application 22 and is not associated with the network computing device 16.

In an example of operation, the source computing device 12 and the destination computing device 14 interact via the interface means 18. For example, the source computing device 12 establishes a direct communication link with the destination computing device 14 via near-field communication (NFC) interface means 18. The source computing device 12 sends real-time payment information 50 to the network computing device 16 via its network application 22. The real-time payment information 50 includes the source real-time payment information (e.g., the source identifier (ID) and a type of cryptocurrency it wishes to use in a real-time payment to the destination computing device 14), the destination real-time payment information (e.g., a destination identifier (ID) and a type of desired it wishes to receive in the real-time payment from the source computing device 12), and the amount of the real-time payment. The source computing device 12 receives the destination real-time payment information via the interface means 18.

When the network computing device 16 receives the real-time payment information 50, the network computing device initiates 1) a real-time cryptocurrency-based payment process (e.g., the real-time cryptocurrency-based payment loop 28) and 2) a nonreal time reconciliation process to reconcile the cryptocurrency-based payment with the cryptocurrency-based payment backing account device 20 (e.g., the nonreal-time reconciliation of the cryptocurrency-based payment loop 30). The reconciliation of the cryptocurrency-based payment with the cryptocurrency-based payment backing account device 20 occurs within a time frame that is longer than the time frame of the real-time cryptocurrency-based payment.

Within the nonreal-time reconciliation of the cryptocurrency-based payment loop 30, when the real-time payment information is received, the network computing device 16 instructs the cryptocurrency-based payment backing account device 20 to lock an amount of system cryptocurrency associated with the real-time cryptocurrency-based payment.

Within the real-time cryptocurrency-based payment loop 28, when the network computing device 16 receives an amount of cryptocurrency from the source computing device 12 to use in the real-time cryptocurrency-based payment, a network acknowledgment (ACK) of the receipt of the amount of the cryptocurrency is generated. If the payment is terminated (e.g., payment initiation fails and/or is cancelled by the source and/or the destination computing device) within a certain amount of time prior to the network computing device 16 continuing with the following steps of the real-time cryptocurrency-based payment loop 28, the ACK is not generated, and the real-time payment terminates. Within the nonreal-time reconciliation of the cryptocurrency-based payment loop 30, when the ACK is not generated, the network computing device 16 instructs the cryptocurrency-based payment backing account device 20 to release the amount of locked system cryptocurrency.

Continuing with the real-time cryptocurrency-based payment loop 28, when the ACK is generated, the network computing device 16 exchanges the amount of the cryptocurrency received from the source computing device 12 to an amount of the desired currency 52. Cryptocurrency exchange is done quickly (e.g., 30 seconds to a few minutes) to account for exchange rate volatility. The exchange can also be performed in real time on a credit-based account to eliminate any pricing volatility. The network computing device 16 sends the amount of the desired currency 52 to the source computing device 12. The source computing device 12 then sends a payment in the amount of the desired currency 48 to the destination computing device 14 to complete the real-time cryptocurrency-based payment.

The remainder of the nonreal-time reconciliation of the cryptocurrency-based payment loop 30 operates similarly to the cryptocurrency payment system 10 of FIG. 1.

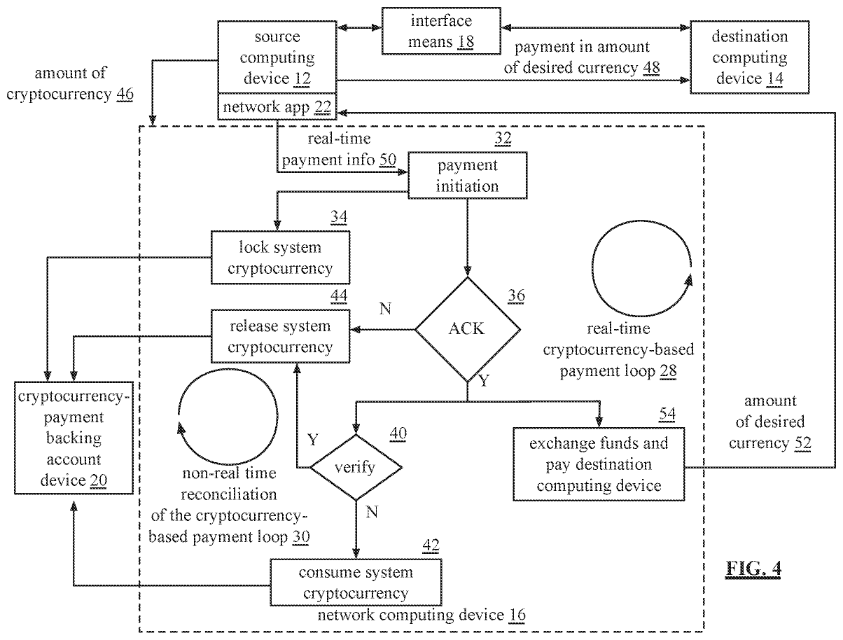

FIG. 4 is a flowchart of an example of a method for execution by a network computing device 16 of the cryptocurrency payment system 10 of FIG. 3. FIG. 4 includes a source computing device 12, a destination computing device 14, a network computing device 16, an interface means 18, and a cryptocurrency-based payment backing account device 20. In this example, the source computing device 12 includes a network application 22 (e.g., network app 22) that associates the source computing device 12 to the network computing device 16. However, the destination computing device 14 is not associated with the network computing device 16.

The method begins with step 32 where the network computing device 16 receives real-time payment information 50 regarding a cryptocurrency-based payment from a source computing device 12 to a destination computing device 14. For example, the source computing device 12 sends the real-time payment information 50 to the network computing device 16 via its network application 22. The real-time payment information 50 includes the source real-time payment information (e.g., the source identifier (ID) and a type of cryptocurrency it wishes to use in a real-time payment to the destination computing device 14), the destination real-time payment information (e.g., a destination identifier (ID) and a type of desired it wishes to receive in the real-time payment from the source computing device 12), and the amount of the real-time payment. The source computing device 12 receives the destination real-time payment information via the interface means 18.

When the network computing device 16 receives the real-time payment information, the network computing device initiates 1) a real-time cryptocurrency-based payment process (e.g., the real-time cryptocurrency-based payment loop 28) and 2) a nonreal time reconciliation process to reconcile the cryptocurrency-based payment with the cryptocurrency-based payment backing account device 20 (e.g., the nonreal-time reconciliation of the cryptocurrency-based payment loop 30) (i.e., “payment initiation”). The reconciliation of the cryptocurrency-based payment with the cryptocurrency-based payment backing account device 20 occurs within a time frame that is longer than the time frame of the real-time cryptocurrency-based payment.

The method continues with step 34 where, within the nonreal-time reconciliation of the cryptocurrency-based payment loop 30, the network computing device 16 instructs the cryptocurrency-based payment backing account device 20 to lock an amount of system cryptocurrency associated with the real-time cryptocurrency-based payment.

The method continues with step 36 where a network acknowledgment (ACK) of the receipt of the amount of the cryptocurrency is or is not generated. For example, when the network computing device 16 receives an amount of cryptocurrency 46 from the source computing device 12 to use in the real-time cryptocurrency-based payment, the ACK is generated and the method continues to steps 38 and 40. If the payment is terminated (e.g., payment initiation fails and/or is cancelled by the source and/or the destination computing device) within a certain amount of time prior to the network computing device 16 continuing with the following steps of the real-time cryptocurrency-based payment loop 28, the ACK is not generated, and the real-time payment fails. Within the nonreal-time reconciliation of the cryptocurrency-based payment loop 30, when the ACK is not generated, the method continues with step 44 where the network computing device 16 instructs the cryptocurrency-based payment backing account device 20 to release the amount of locked system cryptocurrency.

Within the real-time cryptocurrency-based payment loop 28, when the ACK is generated, the method continues with step 54 where the network computing device 16 exchanges the amount of the cryptocurrency 46 received from the source computing device 12 to an amount of the desired currency. Cryptocurrency exchange is done quickly (e.g., 30 seconds to a few minutes) to account for exchange rate volatility. The network computing device 16 sends the amount of the desired currency 52 to the source computing device 12. The source computing device 12 then sends the payment in the amount of the desired currency 48 to the destination computing device 14 to complete the real-time cryptocurrency-based payment. The remainder of the method operates similarly to the method of FIG. 2.

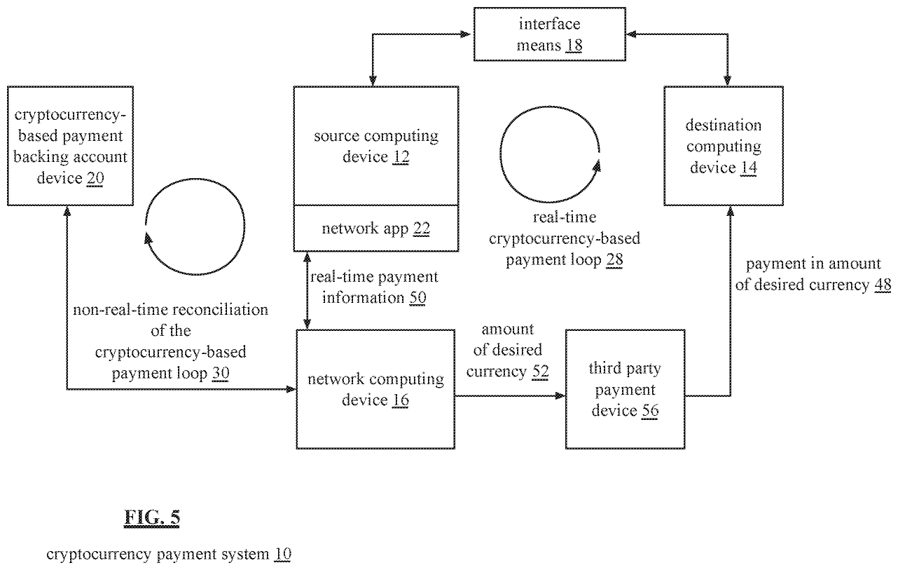

FIG. 5 is a schematic block diagram of another embodiment of a cryptocurrency payment system 10 that includes a source computing device 12, a destination computing device 14, a network computing device 16, an interface means 18, a cryptocurrency-based payment backing account device 20, and a third party payment device 56. The cryptocurrency payment system 10 of FIG. 5 operates similarly to the cryptocurrency payment system 10 of FIG. 3 except that the network computing device 16 coordinates payment to the destination computing device 14 through the third party payment device 56. The third party payment device 56 may be a cryptocurrency exchange and holding device. Alternatively, the third party payment device 56 is a store value account (SVA) or gift card generating device.

In an example of operation, the source computing device 12 and the destination computing device 14 interact via the interface means 18. For example, the source computing device 12 establishes a direct communication link with the destination computing device 14 via NFC interface means 18. The source computing device 12 sends real-time payment information 50 to the network computing device 16 via its network application 22. The real-time payment information 50 includes the source real-time payment information (e.g., the source identifier (ID) and a type of cryptocurrency it wishes to use in a real-time payment to the destination computing device 14), the destination real-time payment information (e.g., a destination identifier (ID) and a type of desired it wishes to receive in the real-time payment from the source computing device 12), and the amount of the real-time payment. The source computing device 12 receives the destination real-time payment information via the interface means 18.

When the network computing device 16 receives the real-time payment information 50, the network computing device initiates 1) a real-time cryptocurrency-based payment process (e.g., the real-time cryptocurrency-based payment loop 28) and 2) a nonreal time reconciliation process to reconcile the cryptocurrency-based payment with the cryptocurrency-based payment backing account device 20 (e.g., the nonreal-time reconciliation of the cryptocurrency-based payment loop 30). The reconciliation of the cryptocurrency-based payment with the cryptocurrency-based payment backing account device 20 occurs within a time frame that is longer than the time frame of the real-time cryptocurrency-based payment.

Within the nonreal-time reconciliation of the cryptocurrency-based payment loop 30, when the real-time payment information is received, the network computing device 16 instructs the cryptocurrency-based payment backing account device 20 to lock an amount of system cryptocurrency associated with the real-time cryptocurrency-based payment.

Within the real-time cryptocurrency-based payment loop 28, when the network computing device 16 receives an amount of cryptocurrency from the source computing device 12 to use in the real-time cryptocurrency-based payment, a network acknowledgment (ACK) of the receipt of the amount of the cryptocurrency is generated. If the payment is cancelled within a certain amount of time prior to the network computing device 16 continuing with the following steps of the real-time cryptocurrency-based payment loop 28 (e.g., payment initiation fails and/or is cancelled by the source and/or the destination computing device), the ACK is not generated, and the real-time payment terminates. Within the nonreal-time reconciliation of the cryptocurrency-based payment loop 30, when the ACK is not generated, the network computing device 16 instructs the cryptocurrency-based payment backing account device 20 to release the amount of locked system cryptocurrency.

Continuing with the real-time cryptocurrency-based payment loop 28, when the ACK is generated, the network computing device 16 exchanges the amount of the cryptocurrency received from the source computing device 12 to an amount of the desired currency 52. Cryptocurrency exchange is done quickly (e.g., 30 seconds to a few minutes) to account for exchange rate volatility. The exchange can also be performed in real time on a credit-based account to eliminate any pricing volatility.

The network computing device 16 sends the amount of the desired currency 52 to the third party payment device 56. The third party payment device 56 then sends a payment in the amount of the desired currency 48 to the destination computing device 14 to complete the real-time cryptocurrency-based payment. Alternatively, the network computing device 16 sends the amount of cryptocurrency to the third party payment device 56. The third party payment device 56 exchanges the amount of cryptocurrency to the amount of the desired currency and sends a payment in the amount of the desired currency 48 to the destination computing device 14 to complete the real-time cryptocurrency-based payment.

The remainder of the nonreal-time reconciliation of the cryptocurrency-based payment loop 30 operates similarly to the cryptocurrency payment system 10 of FIG. 1.

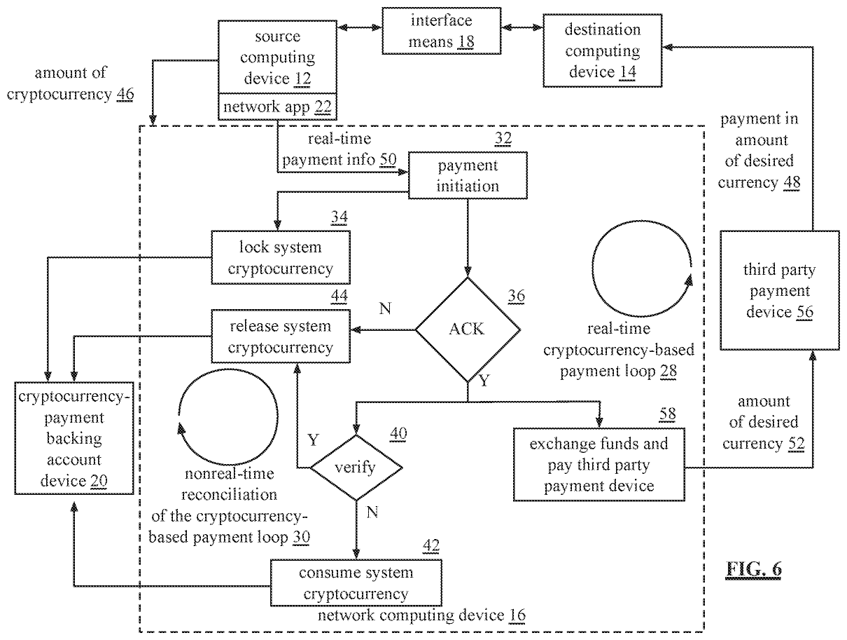

FIG. 6 is a flowchart of an example of a method for execution by a network computing device 16 of the cryptocurrency payment system 10 of FIG. 5. FIG. 6 includes a source computing device 12, a destination computing device 14, a network computing device 16, an interface means 18, a cryptocurrency-based payment backing account device 20, and a third party payment device 56. In this example, the source computing device 12 includes a network application 22 (e.g., network app 22) that associates the source computing device 12 to the network computing device 16. However, the destination computing device 14 is not associated with the network computing device 16.

The method begins with step 32 where the network computing device 16 receives real-time payment information 50 regarding a cryptocurrency-based payment from a source computing device 12 to a destination computing device 14. For example, the source computing device 12 sends the real-time payment information 50 to the network computing device 16 via its network application 22. The real-time payment information 50 includes the source real-time payment information (e.g., the source identifier (ID) and a type of cryptocurrency it wishes to use in a real-time payment to the destination computing device 14), the destination real-time payment information (e.g., a destination identifier (ID) and a type of desired it wishes to receive in the real-time payment from the source computing device 12), and the amount of the real-time payment. The source computing device 12 receives the destination real-time payment information via the interface means 18.

When the network computing device 16 receives the real-time payment information, the network computing device initiates 1) a real-time cryptocurrency-based payment process (e.g., the real-time cryptocurrency-based payment loop 28) and 2) a nonreal time reconciliation process to reconcile the cryptocurrency-based payment with the cryptocurrency-based payment backing account device 20 (e.g., the nonreal-time reconciliation of the cryptocurrency-based payment loop 30) (i.e., “payment initiation”). The reconciliation of the cryptocurrency-based payment with the cryptocurrency-based payment backing account device 20 occurs within a time frame that is longer than the time frame of the real-time cryptocurrency-based payment.

The method continues with step 34 where, within the nonreal-time reconciliation of the cryptocurrency-based payment loop 30, the network computing device 16 instructs the cryptocurrency-based payment backing account device 20 to lock an amount of system cryptocurrency associated with the real-time cryptocurrency-based payment.

The method continues with step 36 where a network acknowledgment (ACK) of the receipt of the amount of the cryptocurrency is or is not generated. For example, when the network computing device 16 receives an amount of cryptocurrency 46 from the source computing device 12 to use in the real-time cryptocurrency-based payment, the ACK is generated and the method continues to steps 38 and 40. If the payment is terminated (e.g., payment initiation fails and/or is cancelled by the source and/or the destination computing device) within a certain amount of time prior to the network computing device 16 continuing with the following steps of the real-time cryptocurrency-based payment loop 28, the ACK is not generated, and the real-time payment terminates. Within the nonreal-time reconciliation of the cryptocurrency-based payment loop 30, when the ACK is not generated, the method continues with step 44 where the network computing device 16 instructs the cryptocurrency-based payment backing account device 20 to release the amount of locked system cryptocurrency.

Within the real-time cryptocurrency-based payment loop 28, when the ACK is generated, the method continues with step 58 where the network computing device 16 exchanges the amount of the cryptocurrency 46 received from the source computing device 12 to an amount of the desired currency. Cryptocurrency exchange is done quickly (e.g., 30 seconds to a few minutes) to account for exchange rate volatility. The network computing device 16 sends the amount of the desired currency 52 to the third party payment device 56. The third party payment device 56 then sends the payment in the amount of the desired currency 48 to the destination computing device 14 to complete the real-time cryptocurrency-based payment.

Alternatively, the network computing device 16 sends the amount of cryptocurrency to the third party payment device 56. The third party payment device 56 exchanges the amount of cryptocurrency to the amount of the desired currency and sends a payment in the amount of the desired currency 48 to the destination computing device 14 to complete the real-time cryptocurrency-based payment. The remainder of the method operates similarly to the method of FIG. 2.

FIG. 7 is a schematic block diagram of an embodiment of a cryptocurrency payment system 10 that includes a source computing device 12, a destination computing device 14, a network computing device 16, an interface means 18, and a cryptocurrency-based payment backing account device 20. FIG. 7 operates similarly to FIG. 1 except the cryptocurrency-based payment backing account device 20 is shown in more detail.

The cryptocurrency-based payment backing account device 20 includes a plurality of cryptocurrency-based payment backing accounts 60-1 through 60-n. The plurality of cryptocurrency-based payment backing accounts 60-1 through 60-n store system cryptocurrency 62-1 through 62-n as collateral to back real-time cryptocurrency-based payments associated with the respective cryptocurrency-based payment backing accounts 60-1 through 60-n.

The system cryptocurrency is any cryptocurrency the cryptocurrency payment system 10 chooses to use for collateral. For example, the system cryptocurrency is a cryptocurrency (e.g., a token on the Ethereum blockchain) specifically created for use in the system. As another example, the system cryptocurrency is an already established and trusted cryptocurrency.

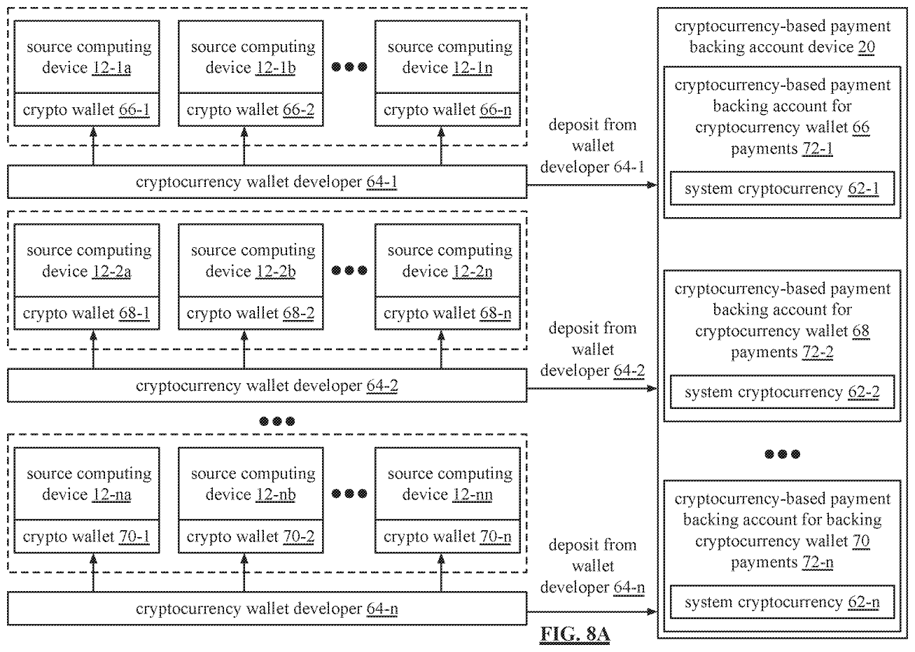

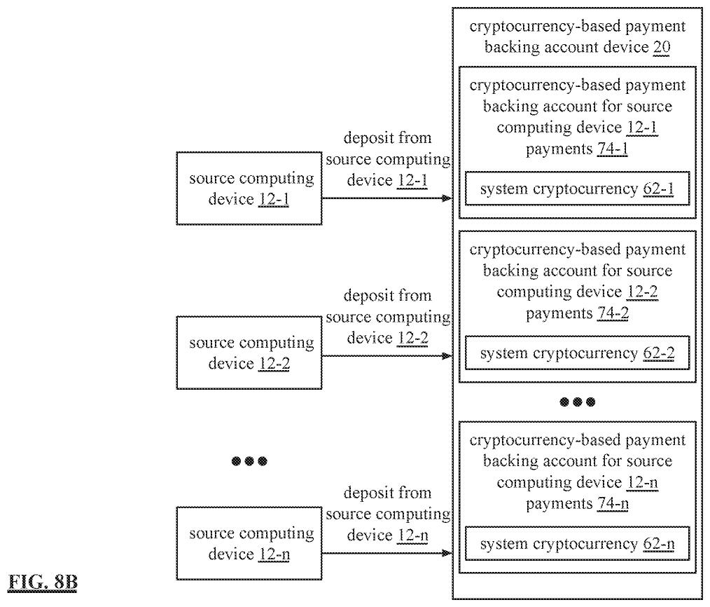

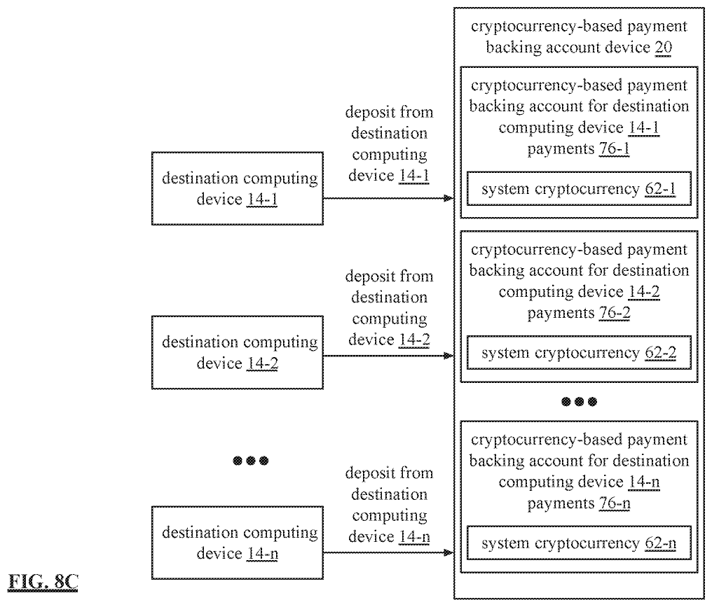

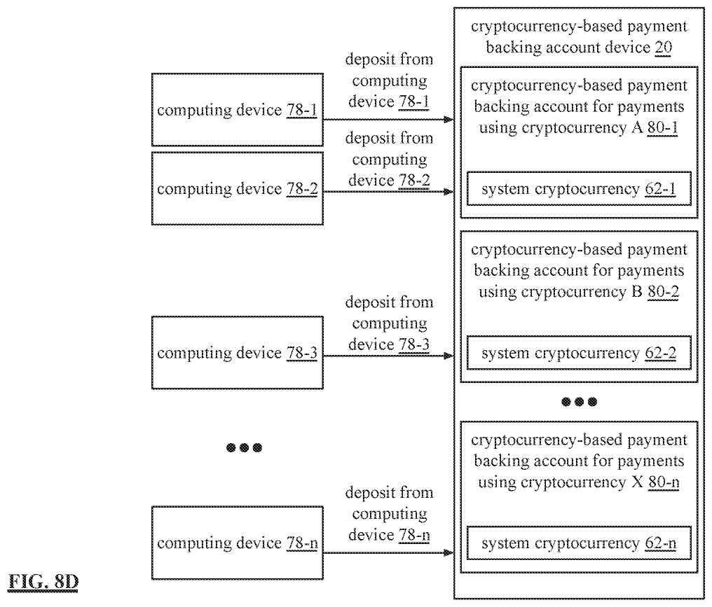

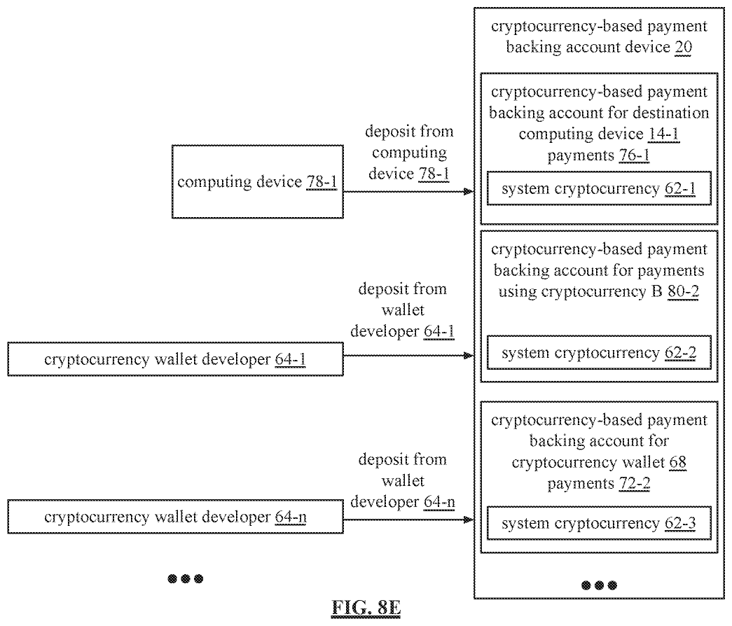

The plurality of cryptocurrency-based payment backing accounts 60-1 through 60-n are each associated either the source computing device 12, the destination computing device 14, or a type of cryptocurrency. Most commonly, a cryptocurrency-based payment account 20 is associated with the source computing device 12. The different types of cryptocurrency-based payment backing account associations will be discussed in more detail with reference to FIGS. 8A-8E.

The cryptocurrency-based payment backing account device 20 is operable to receive commands from the network computing device 16 regarding a cryptocurrency-based payment from the source computing device 12 to the destination computing device 14.

In an example of operation, the cryptocurrency-based payment backing account device 20 receives a lock instruction from the network computing device 16 to lock an amount of system cryptocurrency-based on real-time payment information (e.g., the source real-time payment information 24 and the destination real-time payment information 26) regarding a cryptocurrency-based payment from the source computing device 12 to the destination computing device 14. The source real-time payment information 24 includes a source identifier (ID) and a type of cryptocurrency it wishes to use in a real-time payment to the destination computing device 14. The destination real-time payment information 26 includes a destination identifier (ID) and a type of desired currency (e.g., a fiat currency, another cryptocurrency, etc.) it wishes to receive in the real-time payment from the source computing device 12. One or more of the source real-time payment information 24 and the destination real-time payment information 26 includes the amount of the real-time payment.

The cryptocurrency-based payment backing account device 20 determines a cryptocurrency-based payment backing account of the plurality of cryptocurrency-based payment backing accounts 60-1 through 60-n associated with the real-time payment information. For example, the cryptocurrency-based payment backing account device 20 determines that the cryptocurrency-based payment backing account 60-1 is associated with the source ID.

In another example, the cryptocurrency-based payment backing account device 20 determines that the cryptocurrency-based payment backing account 60-2 is associated with the destination ID. In another example, the cryptocurrency-based payment backing account device 20 determines that the cryptocurrency-based payment backing account 60-n is associated with the type of cryptocurrency the source computing device 12 wishes to use in the real-time payment.

The cryptocurrency-based payment backing account device 20 then locks the amount of system cryptocurrency stored in the cryptocurrency-based payment backing account until a release instruction or a consume instruction is received from the network computing device 16. For example, when the cryptocurrency-based payment backing account device 20 determines that the cryptocurrency-based payment backing account 60-1 is associated with the source ID, the cryptocurrency-based payment backing account device 20 locks an amount of the system cryptocurrency 62-1 stored in the cryptocurrency-based payment backing account 60-1.

The amount of the system cryptocurrency locked may be based on the amount of the real-time payment and/or one or more properties of the cryptocurrency-based payment backing account, the source computing device, and the destination computing device. For example, the amount of the system cryptocurrency locked is equal to the amount of the real-time payment. As another example, the amount of the system cryptocurrency locked is based on how much the source computing device typically spends. As another example, the amount of the system cryptocurrency locked is based on the type of merchandise the destination computing device sells (e.g., a larger amount is locked for a merchant that sells high end goods).

The amount of the system cryptocurrency locked remains locked until a release instruction or a consume instruction is received from the network computing device 16. When the release instruction from the network computing device 16 is received the cryptocurrency-based payment backing account device 20 releases the amount of the system cryptocurrency to the cryptocurrency-based payment backing account. The release instruction is received after a cryptocurrency payment from the source computing device 12 has been verified and the payment is successful or when the cryptocurrency payment initiation is terminated (e.g., fails and/or is cancelled prior to the network computing device 16 sending payment to the destination computing device).

When the consume instruction from the network computing device 16 is received, the cryptocurrency-based payment backing account device 20 sends the amount of the system cryptocurrency to an account associated with the network computing device 16 to cover the real-time cryptocurrency-based payment. The account associated with the network computing device 16 may be stored in the cryptocurrency-based payment backing account device 20, the network computing device 16, or as a stand-alone computing device. The consume instruction is received when the cryptocurrency payment from the source computing device 12 has not been successfully verified, however, the real-time cryptocurrency payment has occurred.

FIGS. 8A-8E are schematic block diagrams of examples of a cryptocurrency-based payment backing account device 20. The cryptocurrency-based payment backing account device 20 allows individuals and entities to provide backing for cryptocurrency payment system transactions. In exchange for the risk of backing transactions and adding to the security of the cryptocurrency payment system, the individuals and entities are provided rewards.

FIG. 8A shows the most common example of a cryptocurrency-based payment backing account where a plurality of cryptocurrency wallet developers 64-1 through 64-n establish cryptocurrency-based payment backing accounts with the cryptocurrency-based payment backing account device 20 to back the payments made by their cryptocurrency wallet users.

For example, the cryptocurrency wallet developer 64-1 developed a cryptocurrency wallet 66. In order to make the cryptocurrency wallet 66 usable in the cryptocurrency payment system 10, the cryptocurrency wallet developer 64-1 establishes a cryptocurrency-based payment backing account for cryptocurrency wallet 66 payments 72-1 and deposits system cryptocurrency 62-1 into the cryptocurrency-based payment backing account for cryptocurrency wallet 66 payments 72-1. The source computing devices 12-1a through 12-1n each store the cryptocurrency wallet 66-1 through 66-n to make cryptocurrency-based payments in the cryptocurrency payment system 10 and the system cryptocurrency 62-1 stored in the cryptocurrency-based payment backing account for cryptocurrency wallet 66 payments 72-1 backs those payments.

In exchange for establishing a cryptocurrency-based payment backing account, a developer of a cryptocurrency wallet receives rewards from the cryptocurrency-based account device 20 such as a percentage of system cryptocurrency for every successful payment made by its wallet's users. Because the developer is backing wallet user payments, the developer is incentivized to produce a quality digital wallet that prevents user fraud and to correct faulty digital wallet software. The cryptocurrency-based payment backing account set up and rewards incentives are further described in co-pending patent application Ser. No. 16/695,459 entitled, “SECURE AND TRUSTED CRYPTOCURRENCY ACCEPTANCE SYSTEM,” filed Nov. 26, 2019.

FIG. 8A further shows additional cryptocurrency wallet developers 64-2 through 64-n. The cryptocurrency wallet developer 64-2 developed a cryptocurrency wallet 68. In order to make the cryptocurrency wallet 68 usable in the cryptocurrency payment system 10, the cryptocurrency wallet developer 64-2 establishes a cryptocurrency-based payment backing account for cryptocurrency wallet 68 payments 72-2 and deposits system cryptocurrency 62-2 into the cryptocurrency-based payment backing account for cryptocurrency wallet 68 payments 72-2. The source computing devices 12-2a through 12-2n each store the cryptocurrency wallet 68-1 through 68-n to make cryptocurrency-based payments in the cryptocurrency payment system 10 and the system cryptocurrency 62-2 stored in the cryptocurrency-based payment backing account for cryptocurrency wallet 68 payments 72-2 backs those payments.

The cryptocurrency wallet developer 64-n developed a cryptocurrency wallet 70. In order to make the cryptocurrency wallet 70 usable in the cryptocurrency payment system 10, the cryptocurrency wallet developer 64-n establishes a cryptocurrency-based payment backing account for cryptocurrency wallet 70 payments 72-n and deposits system cryptocurrency 62-n into the cryptocurrency-based payment backing account for cryptocurrency wallet 70 payments 72-n. The source computing devices 12-na through 12-nn each store the cryptocurrency wallet 70-1 through 70-n to make cryptocurrency-based payments in the cryptocurrency payment system 10 and the system cryptocurrency 62-n stored in the cryptocurrency-based payment backing account for cryptocurrency wallet 70 payments 72-n backs those payments.

FIG. 8B shows an example where an individual generates a cryptocurrency-based payment backing account with the cryptocurrency-based payment backing account device 20 to back its own payments within the cryptocurrency payment system 10. For example, FIG. 8B includes source computing devices 12-1 through 12-n where each source computing device is associated with an individual user.

The source computing device 12-1 establishes a cryptocurrency-based payment backing account for source computing device 12-1 payments 74-1 with the cryptocurrency-based payment backing account device 20 and deposits system cryptocurrency 62-1 into the cryptocurrency-based payment backing account for source computing device 12-1 payments 74-1 to back its own payments within the cryptocurrency payment system 10. The source computing device 12-2 establishes a cryptocurrency-based payment backing account for source computing device 12-2 payments 74-2 with the cryptocurrency-based payment backing account device 20 and deposits system cryptocurrency 62-2 into the cryptocurrency-based payment backing account for source computing device 12-2 payments 74-2 to back its own payments within the cryptocurrency payment system 10.

Similarly, the source computing device 12-n establishes a cryptocurrency-based payment backing account for source computing device 12-n payments 74-n with the cryptocurrency-based payment backing account device 20 and deposits system cryptocurrency 62-n into the cryptocurrency-based payment backing account for source computing device 12-n payments 74-n to back its own payments within the cryptocurrency payment system 10.

A typical user of the cryptocurrency payment system 10 may not have the funds to establish a cryptocurrency-based payment backing account on its own behalf or simply may not wish to be involved in this process. However, for certain users with funds and the desire to set up an individual account, would receive direct rewards from the cryptocurrency-based payment backing account device 20 for its own successful transactions. Further, setting up an individual account provides the individual user freedom to use any cryptocurrency payment cryptocurrency wallet of its choice.

FIG. 8C shows an example where a destination computing device 14 generates a cryptocurrency-based payment backing account with the cryptocurrency-based payment backing account device 20 to back payments received within the cryptocurrency payment system 10. For example, FIG. 8C includes destination computing devices 14-1 through 14-n. A destination computing device may be associated with an individual user and/or a merchant.

The destination computing device 14-1 establishes a cryptocurrency-based payment backing account for destination computing device 14-1 payments 76-1 with the cryptocurrency-based payment backing account device 20 and deposits system cryptocurrency 62-1 into the cryptocurrency-based payment backing account for destination computing device 14-1 payments 76-1 to back payments it receives within the cryptocurrency payment system 10. The destination computing device 14-2 establishes a cryptocurrency-based payment backing account for destination computing device 14-2 payments 76-2 with the cryptocurrency-based payment backing account device 20 and deposits system cryptocurrency 62-2 into the cryptocurrency-based payment backing account for destination computing device 12-2 payments 76-2 to back payments it received within the cryptocurrency payment system 10.

Similarly, the destination computing device 14-n establishes a cryptocurrency-based payment backing account for destination computing device 14-n payments 76-n with the cryptocurrency-based payment backing account device 20 and deposits system cryptocurrency 62-n into the cryptocurrency-based payment backing account for destination computing device 14-n payments 76-n to back payments it receives within the cryptocurrency payment system 10.

There is less incentive for a destination computing device to want to set up a cryptocurrency-based payment backing account to back received payments. The destination computing device would need the funds to establish an account and to trust the payments received by source computing devices (e.g., consumers in a merchant/consumer scenario). Plus, the destination computing device would need to take the time to set up the account.

However, as discussed previously, a cryptocurrency-based payment backing account receives direct rewards from the cryptocurrency-based payment backing account device 20 for its successful payments. Therefore, while the upfront set up may require effort and money, a destination computing device 14 will receive the long term benefits of a percentage back on all successful payments. In order to establish trusted payments, the destination computing device 14 could develop a customer loyalty program to gain knowledge about customers prior to accepting payments. If customer fraud is detected, the customer would lose its loyal customer status and no longer be able to make cryptocurrency-based payments to the destination computing device 14.

FIG. 8D shows an example where a cryptocurrency-based payment backing account is established to back payments using a particular cryptocurrency wallet. For example, a cryptocurrency-based payment backing account is established to back payments using cryptocurrency A 80-1 wallet, a cryptocurrency-based payment backing account is established to back payments using cryptocurrency B 80-2 wallet, and a cryptocurrency-based payment backing account is established to back payments using cryptocurrency X 80-n wallet.

Any user of the cryptocurrency payment system may have established any of the accounts shown and any user of the of the cryptocurrency payment system can contribute system cryptocurrency to any of the accounts. For example, the computing devices 78-1 through 78-2 deposit cryptocurrency 62-1 into the cryptocurrency-based payment backing account for payments using cryptocurrency A 80-1, a computing device 78-3 deposits cryptocurrency 62-2 into the cryptocurrency-based payment backing account for payments using cryptocurrency B 80-2, and a computing device 78-n deposits cryptocurrency 62-n into the cryptocurrency-based payment backing account for payments using cryptocurrency X 80-n.

Those who deposit system cryptocurrency into a cryptocurrency-based payment backing account receive rewards from the cryptocurrency-based payment backing account device 20 for successful payments associated with the particular cryptocurrency wallet. For example, a trusted, well known cryptocurrency wallet such as a Bitcoin wallet may have a cryptocurrency-based payment backing account where individual users can deposit system cryptocurrency to back Bitcoin payments. Therefore, a cryptocurrency-based payment backing account device deposit provides a financial incentive in exchange for the risk associated with making the deposit.

FIG. 8E illustrates an example where any type of user of the cryptocurrency payment system can deposit system cryptocurrency into any cryptocurrency-based payment backing account in exchange for financial incentive. In this example, the cryptocurrency-based payment backing account device 20 is shown having a cryptocurrency-based payment backing account for destination computing device 14-1 payments 76-1 storing system cryptocurrency 62-1, a cryptocurrency-based payment backing account for payments using cryptocurrency B 80-2 storing system cryptocurrency 62-2, and a cryptocurrency-based payment backing account for cryptocurrency wallet 68 payments 72-2 storing system cryptocurrency 62-3.

A computing device 78-1 is shown making a deposit of system cryptocurrency into the cryptocurrency-based payment backing account for destination computing device 14-1 payments 76-1. For example, destination computing device 14 may be a reputable merchant with a trusted customer loyalty program that the computing device 78-1 (e.g., an individual user) sees an opportunity for financial return. The computing device 78-1 deposits system cryptocurrency into the account in order to receive a portion of the rewards on successful payments received by the destination computing device 14.

As another example, the cryptocurrency wallet developer 64-1 is shown making a deposit of system cryptocurrency into the cryptocurrency-based payment backing account for payments using cryptocurrency B 80-1. The cryptocurrency wallet developer 64-1 may believe that a cryptocurrency B wallet is a popular and trustworthy cryptocurrency wallet and therefore deposits system cryptocurrency into the account in order to receive a portion of the rewards on successful payments made using cryptocurrency B.

As another example, the cryptocurrency wallet developer 64-n is shown making a deposit of system cryptocurrency into the cryptocurrency-based payment backing account for cryptocurrency wallet 68 payments 72-2. While not its own wallet, the cryptocurrency wallet developer 64-n may believe that cryptocurrency wallet 68 is a popular and trustworthy cryptocurrency wallet and deposits system cryptocurrency into the account in order to receive a portion of the rewards on successful payments made using cryptocurrency wallet 68.

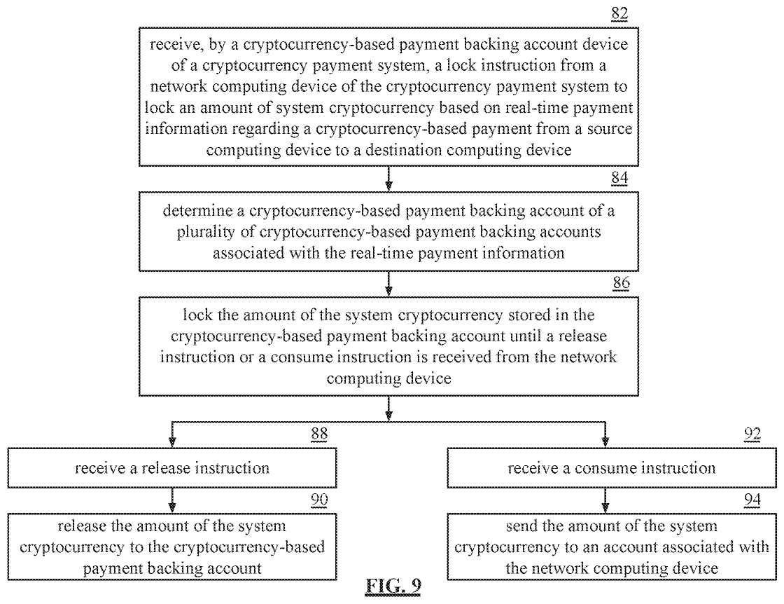

FIG. 9 is a flowchart of an example of a method for execution by a cryptocurrency-based payment backing account device of a cryptocurrency payment system. The method begins with step 82 where the cryptocurrency-based payment backing account device receives a lock instruction from a network computing device of the cryptocurrency payment system to lock an amount of system cryptocurrency-based on real-time payment information regarding a cryptocurrency-based payment from a source computing device to a destination computing device. The cryptocurrency-based payment backing account device includes a plurality of cryptocurrency-based payment backing accounts that store system cryptocurrency to back real-time cryptocurrency-based payments of the cryptocurrency payment system.

The amount of the system cryptocurrency to be locked may be based on the amount of the real-time payment and/or one or more properties of the cryptocurrency-based payment backing account, the source computing device, and the destination computing device. For example, the amount of the system cryptocurrency to be locked is equal to the amount of the real-time payment. As another example, the amount of the system cryptocurrency to be locked is based on how much the source computing device typically spends. As another example, the amount of the system cryptocurrency locked is based on the type of merchandise the destination computing device sells (e.g., a larger amount is locked for a merchant that sells high end goods).

The method continues with step 84 where the cryptocurrency-based payment backing account device determines a cryptocurrency-based payment backing account of the plurality of cryptocurrency-based payment backing accounts associated with the real-time payment information. For example, the real-time payment information includes a source ID that is associated with a cryptocurrency-based payment backing account for the source computing device's cryptocurrency wallet. Additional examples of types of cryptocurrency-based payment backing accounts are discussed with reference to FIGS. 8A-8E.

The method continues with step 86 where the cryptocurrency-based payment backing account device locks the amount of system cryptocurrency stored in the cryptocurrency-based payment backing account until a release instruction or a consume instruction is received from the network computing device. When the cryptocurrency-based payment backing account device receives a release instruction at step 88, the method continues with step 90 where the cryptocurrency-based payment backing account device releases the amount of the system collateral to the cryptocurrency-based payment backing account. The release instruction is received after a cryptocurrency payment from the source computing device has been verified and the real-time cryptocurrency-based payment is successful or when the payment initiation is terminated (e.g., fails and/or is cancelled prior to the network computing device sending payment to the destination computing device).

When the cryptocurrency-based payment backing account device receives a consume instruction at step 92, the method continues with step 94 where the cryptocurrency-based payment backing account device sends the amount of the system cryptocurrency to an account associated with the network computing device. The account associated with the network computing device may be stored in the cryptocurrency-based payment backing account device, the network computing device, or in a stand-alone computing device. The consume instruction is received when the cryptocurrency payment from the source computing device has not been successfully received and/or verified within a certain time threshold, however, the real-time cryptocurrency payment has occurred.

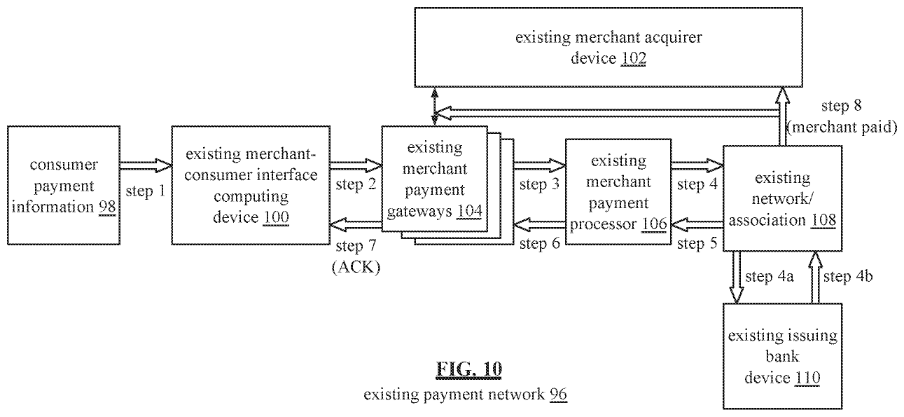

FIG. 10 is a schematic block diagram of an existing payment network 96 that includes consumer payment information 98, an existing merchant-consumer interface computing device 100, an existing merchant acquirer device 102, one or more existing merchant payment gateways 104, an existing merchant payment processor 106, an existing network/association 108, and an existing issuing bank device 110.

The existing merchant-consumer interface computing device 100 is a retail point-of-sale (POS) device (e.g., register having one or more of a computer monitor, touchscreen, payment terminal, barcode scanner, debit/credit card readers, etc.), a credit/debit card terminal, or an e-commerce platform. To initiate a payment at step 1, a consumer provides the consumer payment information 98 to the existing merchant-consumer interface computing device 100. For example, the consumer inserts or swipes a credit or debit card at a POS device or swipes or hovers a consumer device storing the credit or debit card information at a POS device where both devices use near-field communication (NFC) technology. As another example, the consumer enters credit or debit card information into a merchant's e-commerce website to initiate a purchase.

At step 2, the existing merchant-consumer interface computing device 100 the consumer payment information to an existing merchant payment gateway 104. The existing merchant payment gateway 104 may be integrated into the existing merchant-consumer interface computing device 100 or be a separate device (e.g., when the existing merchant-consumer interface computing device 100 is an e-commerce platform). The existing merchant payment gateway 104 acts as a conduit between the existing merchant-consumer interface computing device 100 and the entities that will authorize or decline the debit/credit card payment.

At step 3, the existing merchant payment gateway 104 sends the consumer payment information to an existing merchant payment processor 106. The existing merchant payment processor 106 processes the payment transaction and routes the payment transaction information to the existing network/association 108 (e.g., a credit card association) at step 4. Some existing network/associations 108 are able to approve or decline payment transactions. For those existing network/associations 108, the existing network/associations 108 approves or declines the payment transaction and sends an acknowledgement of the approval/decline to the existing merchant payment processor 106 at step 5.

Some existing network/associations 108 are not able to approve or decline payment transactions. For those existing network/associations 108, the existing network/associations 108 send the payment transaction information to the existing issuing banks device 110 at step 4a. The existing issuing banks device 110 approves or declines the payment transaction and sends an acknowledgement of the approval/decline to the existing network/associations 108 at step 4b. The existing network/associations 108 sends the acknowledgement of the approval/decline to the existing merchant payment processor 106 at step 5.

The existing merchant payment processor 106 sends the acknowledgement of the approval/decline to the existing merchant payment gateway 104 at step 6, and the existing merchant payment gateway 104 pushes the acknowledgement of the approval/decline (ACK) to the existing merchant-consumer interface computing device 100 at step 7 where the consumer is notified whether the payment is approved or declined.

When approved, the existing network/associations 108 send payment to the existing merchant acquirer device 102 (e.g., the merchant bank) at step 8. The existing merchant acquirer device 102 may be associated with the existing merchant payment gateway 104 through a merchant account. Funds may be deposited into the merchant account and then bundled and deposited into the merchant bank at a predetermined time.

As such, the existing payment network 96 involves sending payment information through multiple entities in a round trip. Each step includes encrypting and decrypting the consumer payment information. The existing payment network 96 is slow, involves many potential points of security breach and fraud, and requires fees for the various entities' roles in payment processing.

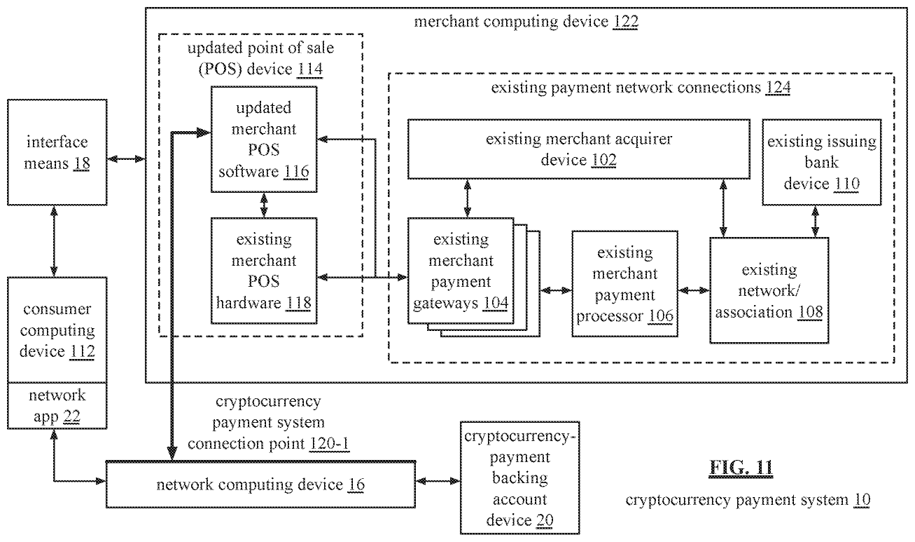

FIG. 11 is a schematic block diagram of another embodiment of the cryptocurrency payment system 10 that includes a consumer computing device 112, a network computing device 16, an interface means 18, a cryptocurrency-payment backing account device 20, and a merchant computing device 122. FIG. 11 operates similarly to the cryptocurrency payment system 10 of FIGS. 1, 3, and 5 except that in FIG. 11, the source computing device 12 is referred to as a consumer computing device 112 and the destination computing device is a merchant computing device 122 that is updated to connect to the cryptocurrency payment system 10 but is also connected to an existing payment network (e.g., the existing payment network 96 of FIG. 10).

The merchant computing device 122 includes an updated point of sale (POS) device 114 and existing payment network connections 124. The updated POS device 114 includes updated merchant POS software 116 that provides a cryptocurrency payment system connection point 120-1 to the network computing device 16 and thus connects the merchant computing device 122 to the cryptocurrency payment system 10.

For example, the updated merchant POS software 116 is a network application that connects the merchant POS device to the network computing device 16 and displays a button on near-field communication (NFC) software for accepting payments via the cryptocurrency payment system. The updated POS device 114 includes existing POS hardware 118 (e.g., a barcode scanner, a card reader, etc.). The updated POS device 114 is operable to connect to the existing payment network connections 124 (e.g., via the existing merchant payment gateways 104) as discussed with reference to FIG. 10.

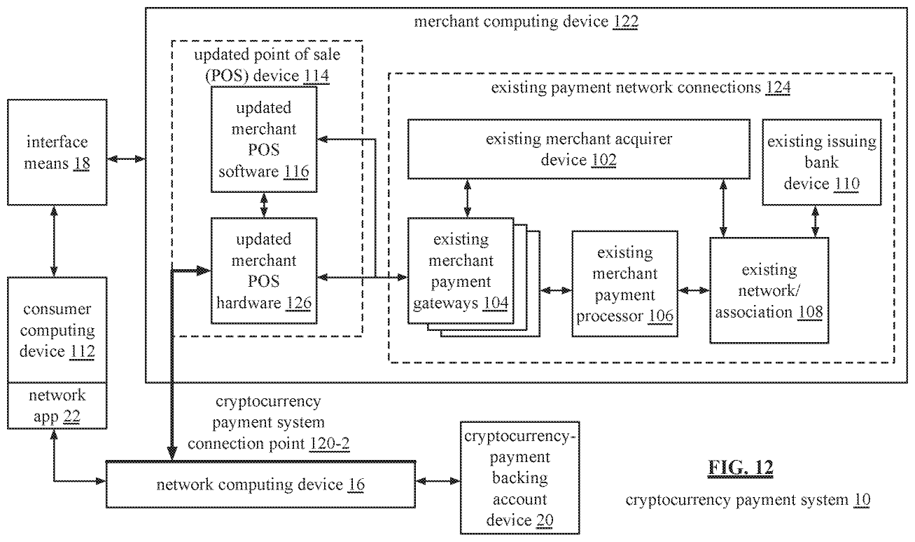

FIG. 12 is a schematic block diagram of another embodiment of the cryptocurrency payment system 10 that includes a consumer computing device 112, a network computing device 16, an interface means 18, a cryptocurrency-payment backing account device 20, and a merchant computing device 122. FIG. 12 operates similarly to the cryptocurrency payment system 10 of FIG. 11 except that the updated POS device 114 of the merchant computing device 122 includes updated merchant POS software 116 and updated merchant POS hardware 126.

For example, the updated POS device 114 includes a network application and updated hardware to generate and/or scan a code (e.g., a barcode, a two-part barcode, etc.) pertaining to cryptocurrency payment system payments. For example, the updated POS device 114 generates code for the consumer to scan. The consumer computing device 112 scans the code as the payment initiation.

In a two-part barcode example, the updated POS device 114 generates one piece of a barcode for the consumer to scan. The consumer computing device 112 generates and presents another piece of a barcode for the updated POS device 114 to scan. The updated POS device 114 is operable to scan and interpret the two pieces as the payment initiation.

One or more of the updated merchant POS software 116 and the updated merchant POS hardware 126 connect the updated POS device 114 to the network computing device 16. In this example, the updated merchant POS hardware 126 provides a cryptocurrency payment system connection point 120-2 to the network computing device 16 and thus connects the merchant computing device 122 to the network computing device 16.

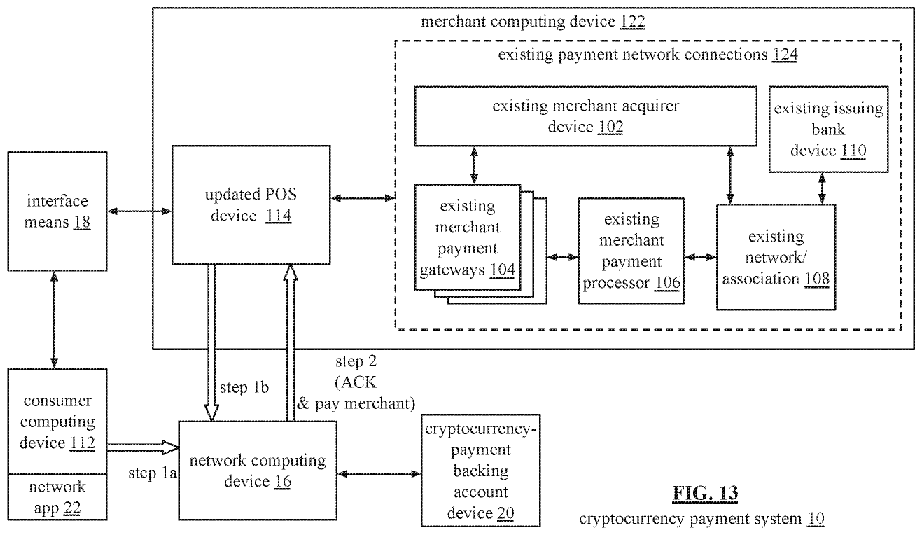

FIG. 13 is a schematic block diagram of a cryptocurrency payment system 10 that includes a consumer computing device 112, a network computing device 16, an interface means 18, a cryptocurrency-payment backing account device 20, and a merchant computing device 122.

FIG. 13 operates similarly to the cryptocurrency payment system 10 of FIGS. 11 and 12 in that the merchant computing device 122 includes the updated POS device 114. FIG. 13 depicts the real-time payment steps involved when the updated POS device 114 is connected to the network computing device 16 (i.e., is part of the cryptocurrency payment system 10).

At steps 1a and 1b, the consumer computing device 112 and the updated POS device 114 provide real-time payment information to the network computing device 16. The real-time payment information includes the consumer real-time payment information (e.g., the consumer identifier (ID) and a type of cryptocurrency it wishes to use in a real-time payment to the merchant computing device 122), the merchant real-time payment information (e.g., a merchant identifier (ID) and a type of desired currency it wishes to receive in the real-time payment from the consumer computing device 112), and the amount of the real-time payment.

When the network computing device 16 receives the real-time payment information, the network computing device initiates 1) a real-time cryptocurrency-based payment process and a nonreal-time reconciliation process to reconcile the cryptocurrency-based payment with the cryptocurrency-based payment backing account device 20. The reconciliation of the cryptocurrency-based payment with the cryptocurrency-based payment backing account device 20 occurs within a time frame that is longer than the time frame of the real-time cryptocurrency-based payment. Here, the steps involving the real-time cryptocurrency-based payment are shown. The reconciliation of the cryptocurrency-based payment with the cryptocurrency-based payment backing account device 20 occurs similarly to the processes described in previous Figures.

When the network computing device 16 receives an amount of cryptocurrency from the consumer computing device 112 to use in the real-time cryptocurrency-based payment, a network acknowledgment (ACK) of the receipt of the amount of the cryptocurrency is generated, the cryptocurrency is exchanged for the merchant's desired currency, and the merchant is paid. The ACK is pushed to the updated POS device 114 at step 2. As compared to the process described in FIG. 10, the ACK of payment is sent to the updated POS device 114 in FIG. 13 much faster and through the use of less entities.

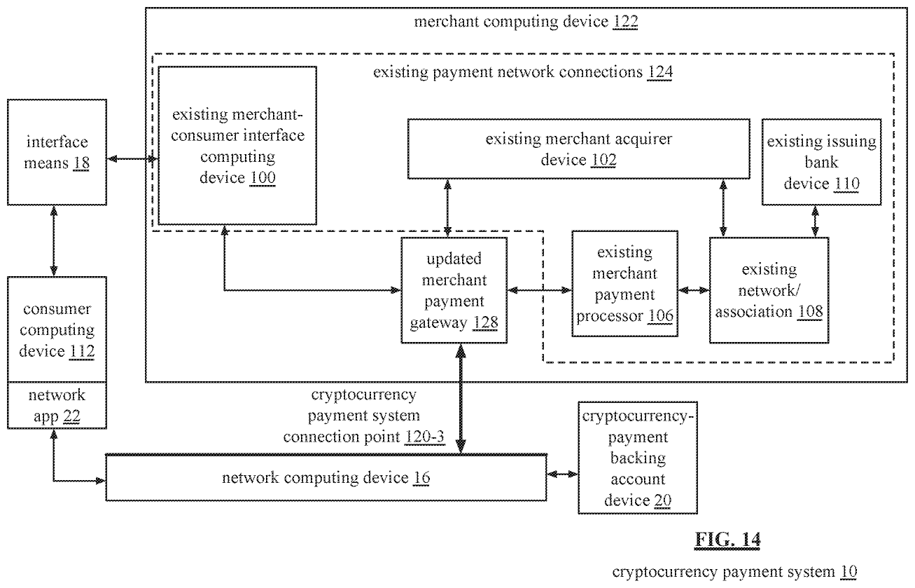

FIG. 14 is a schematic block diagram of another embodiment of the cryptocurrency payment system 10 that includes a consumer computing device 112, a network computing device 16, an interface means 18, a cryptocurrency-payment backing account device 20, and a merchant computing device 122. FIG. 14 operates similarly to the cryptocurrency payment system 10 of FIGS. 11 and 12, except that the merchant computing device 122 includes an existing merchant-consumer interface computing device 100 (e.g., an existing POS device or e-commerce platform) and an updated merchant payment gateway 128. For example, a merchant may not wish to or be able to invest in updating its POS equipment or installing new software into existing POS equipment or e-commerce platforms. However, the merchant can switch from an existing merchant payment gateway to using the updated merchant payment gateway 128 to process cryptocurrency payment system payments.

The updated merchant payment gateway 128 includes software that provides a cryptocurrency payment system connection point 120-3 to the network computing device 16 and thus connects the merchant computing device 122 to the cryptocurrency payment system 10. The updated merchant payment gateway 128 is operable to connect to the existing payment network connections 124 as discussed with reference to FIG. 10.

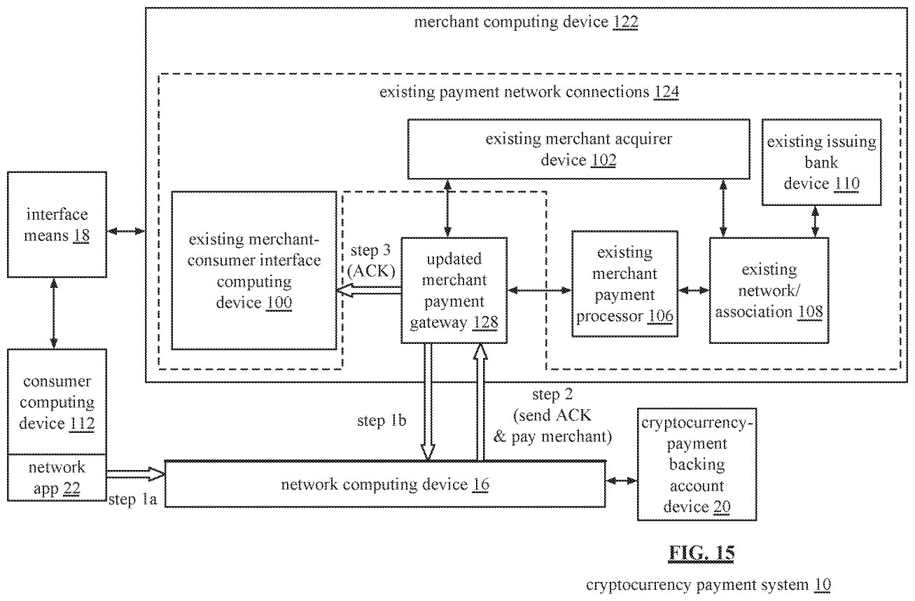

FIG. 15 is a schematic block diagram of a cryptocurrency payment system 10 that includes a consumer computing device 112, a network computing device 16, an interface means 18, a cryptocurrency-payment backing account device 20, and a merchant computing device 122.

FIG. 15 operates similarly to the cryptocurrency payment system 10 of FIG. 14 in that the merchant computing device 122 includes the updated merchant payment gateway 128. FIG. 15 shows the real-time payment steps involved when the updated merchant payment gateway 128 is connected to the network computing device 16 (i.e., is part of the cryptocurrency payment system).

At steps 1a and 1b, the consumer computing device 112 and the updated merchant payment gateway 128 provide real-time payment information to the network computing device 16. The real-time payment information includes the consumer real-time payment information (e.g., the consumer identifier (ID) and a type of cryptocurrency it wishes to use in a real-time payment to the merchant computing device 122), the merchant real-time payment information (e.g., a merchant identifier (ID) and a type of desired currency it wishes to receive in the real-time payment from the consumer computing device 112), and the amount of the real-time payment.

When the network computing device 16 receives the real-time payment information, the network computing device initiates 1) a real-time cryptocurrency-based payment process and a nonreal time reconciliation process to reconcile the cryptocurrency-based payment with the cryptocurrency-based payment backing account device 20. The reconciliation of the cryptocurrency-based payment with the cryptocurrency-based payment backing account device 20 occurs within a time frame that is longer than the time frame of the real-time cryptocurrency-based payment. Here, the steps involving the real-time cryptocurrency-based payment are shown. The reconciliation of the cryptocurrency-based payment with the cryptocurrency-based payment backing account device 20 occurs similarly to processes described in previous Figures.

When the network computing device 16 receives an amount of cryptocurrency from the consumer computing device 112 to use in the real-time cryptocurrency-based payment, a network acknowledgment (ACK) of the receipt of the amount of the cryptocurrency is generated, the cryptocurrency is exchanged for the merchant's desired currency, and the merchant is paid. The ACK is sent to the updated merchant payment gateway 128 at step 2 and is pushed to the existing merchant-consumer interface computing device 100 at step 3 to complete the real-time payment process. As compared to FIG. 10, the ACK of payment is sent to the existing merchant-consumer interface computing device 100 in FIG. 15 much faster and through the use of less entities.

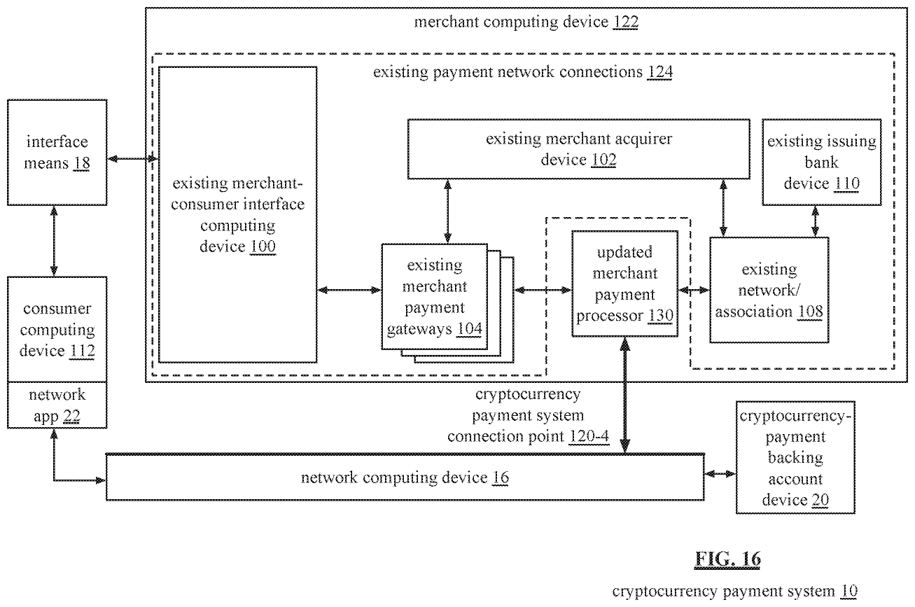

FIG. 16 is a schematic block diagram of another embodiment of the cryptocurrency payment system 10 that includes a consumer computing device 112, a network computing device 16, an interface means 18, a cryptocurrency-payment backing account device 20, and a merchant computing device 122. FIG. 16 operates similarly to the cryptocurrency payment system 10 of FIGS. 11, 12, and 14 except that the merchant computing device 122 includes an existing merchant-consumer interface computing device 100 (e.g., an existing POS device or e-commerce platform), an existing merchant payment gateway 104, and an updated merchant payment processor 130. For example, a merchant may not wish to or be able to invest in updating its POS equipment or installing new software into existing POS equipment or e-commerce platforms. Further, the existing merchant payment gateway may be a part of its POS equipment and not easily updated. However, the merchant can switch from an existing merchant payment processor to using the updated merchant payment processor 130 to process cryptocurrency payment system payments.

The updated merchant payment processor 130 includes software that provides a cryptocurrency payment system connection point 120-4 to the network computing device 16 and thus connects the merchant computing device 122 to the cryptocurrency payment system 10. The updated merchant payment processor 130 is operable to connect to the existing payment network connections 124 as discussed with reference to FIG. 10.

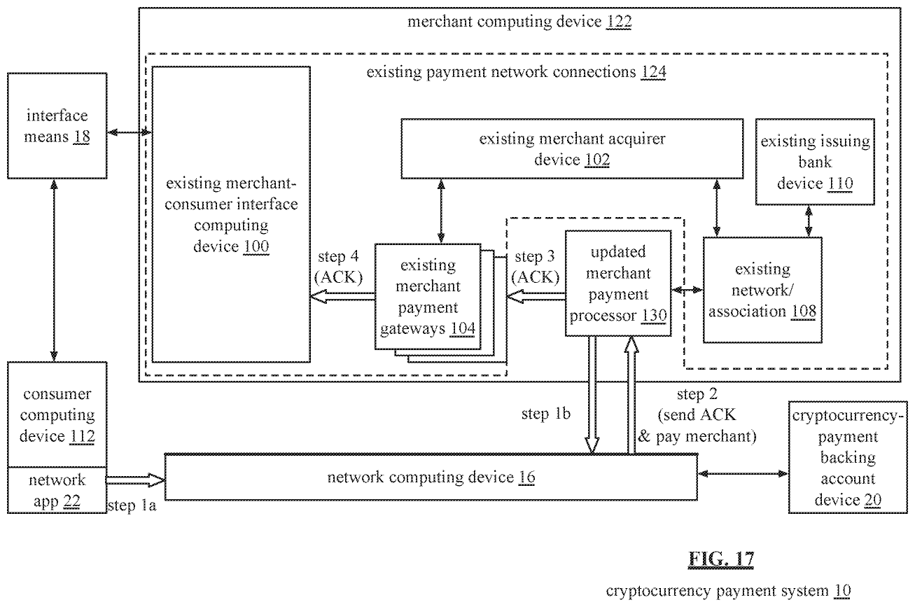

FIG. 17 is a schematic block diagram of a cryptocurrency payment system 10 that includes a consumer computing device 112, a network computing device 16, an interface means 18, a cryptocurrency-payment backing account device 20, and a merchant computing device 122.

FIG. 17 operates similarly to the cryptocurrency payment system 10 of FIG. 16 in that the merchant computing device 122 includes the updated merchant payment processor 130. FIG. 17 shows the real-time payment steps involved when the updated merchant payment processor 130 is connected to the network computing device 16 (i.e., is part of the cryptocurrency payment system).

At steps 1a and 1b, the consumer computing device 112 and the updated merchant payment processor 130 provide real-time payment information to the network computing device 16. The real-time payment information includes the consumer real-time payment information (e.g., the consumer identifier (ID) and a type of cryptocurrency it wishes to use in a real-time payment to the merchant computing device 122), the merchant real-time payment information (e.g., a merchant identifier (ID) and a type of desired currency it wishes to receive in the real-time payment from the consumer computing device 112), and the amount of the real-time payment.

When the network computing device 16 receives the real-time payment information, the network computing device initiates 1) a real-time cryptocurrency-based payment process and a nonreal time reconciliation process to reconcile the cryptocurrency-based payment with the cryptocurrency-based payment backing account device 20. The reconciliation of the cryptocurrency-based payment with the cryptocurrency-based payment backing account device 20 occurs within a time frame that is longer than the time frame of the real-time cryptocurrency-based payment. Here, the steps involving the real-time cryptocurrency-based payment are shown. The reconciliation of the cryptocurrency-based payment with the cryptocurrency-based payment backing account device 20 occurs similarly to processes described in previous Figures.

When the network computing device 16 receives an amount of cryptocurrency from the consumer computing device 112 to use in the real-time cryptocurrency-based payment, a network acknowledgment (ACK) of the receipt of the amount of the cryptocurrency is generated, the cryptocurrency is exchanged for the merchant's desired currency, and the merchant is paid. The ACK is sent to the updated merchant payment processor 130 at step 2, the updated merchant payment processor 130 sends the ACK to the existing merchant payment gateway 104 at step 3 where the ACK is pushed to the existing merchant-consumer interface computing device 100 at step 4 to complete the real-time payment process. As compared to FIG. 10, the ACK of payment is sent to the existing merchant-consumer interface computing device 100 in FIG. 17 faster and through the use of less entities.

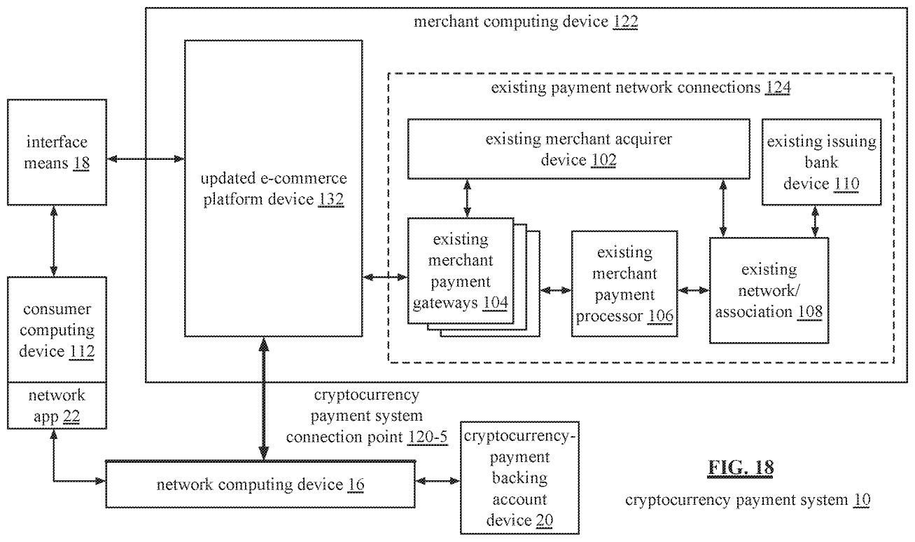

FIG. 18 is a schematic block diagram of another embodiment of the cryptocurrency payment system 10 that includes a consumer computing device 112, a network computing device 16, an interface means 18, a cryptocurrency-payment backing account device 20, and a merchant computing device 122. FIG. 18 operates similarly to the cryptocurrency payment system 10 of FIGS. 11, 12, 14, and 16 except that the merchant computing device 122 includes an updated e-commerce platform device 132. For example, the updated e-commerce platform device 132 includes software that provides a cryptocurrency payment system connection point 120-5 to the network computing device 16 and thus connects the merchant computing device 122 to the cryptocurrency payment system 10. The updated e-commerce platform device 132 is operable to connect to the existing payment network connections 124 as discussed with reference to FIG. 10.

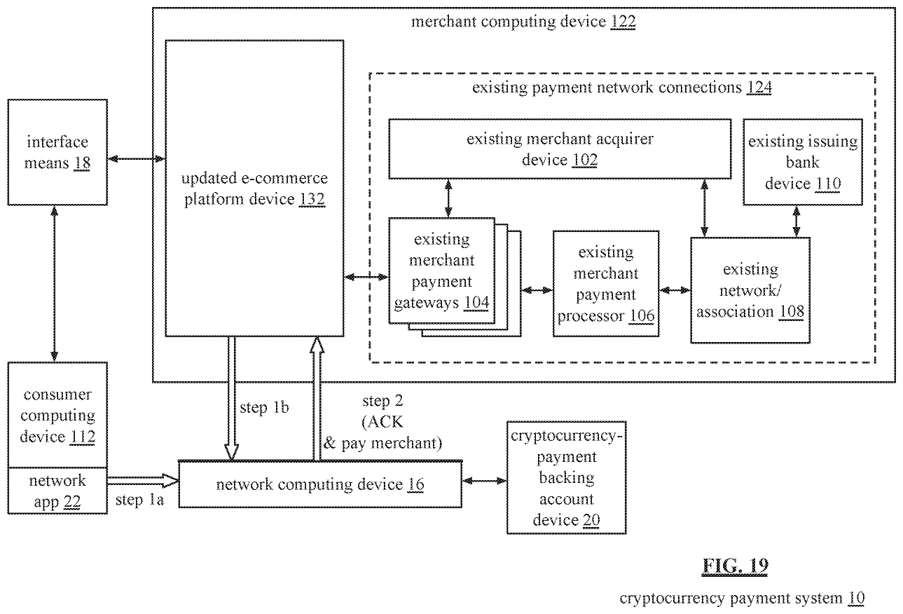

FIG. 19 is a schematic block diagram of a cryptocurrency payment system 10 that includes a consumer computing device 112, a network computing device 16, an interface means 18, a cryptocurrency-payment backing account device 20, and a merchant computing device 122.

FIG. 19 operates similarly to the cryptocurrency payment system 10 of FIG. 18 in that the merchant computing device 122 includes the updated e-commerce platform device 132. FIG. 19 shows the real-time payment steps involved when the updated e-commerce platform device 132 is connected to the network computing device 16 (i.e., is part of the cryptocurrency payment system).

At steps 1a and 1b, the consumer computing device 112 and the updated e-commerce platform device 132 provide real-time payment information to the network computing device 16. The real-time payment information includes the consumer real-time payment information (e.g., the consumer identifier (ID) and a type of cryptocurrency it wishes to use in a real-time payment to the merchant computing device 122), the merchant real-time payment information (e.g., a merchant identifier (ID) and a type of desired currency it wishes to receive in the real-time payment from the consumer computing device 112), and the amount of the real-time payment.

When the network computing device receives the real-time payment information, the network computing device initiates 1) a real-time cryptocurrency-based payment process and a nonreal time reconciliation process to reconcile the cryptocurrency-based payment with the cryptocurrency-based payment backing account device 20. The reconciliation of the cryptocurrency-based payment with the cryptocurrency-based payment backing account device 20 occurs within a time frame that is longer than the time frame of the real-time cryptocurrency-based payment. Here, the steps involving the real-time cryptocurrency-based payment are shown. The reconciliation of the cryptocurrency-based payment with the cryptocurrency-based payment backing account device 20 occurs similarly to processes described in previous Figures.

When the network computing device 16 receives an amount of cryptocurrency from the consumer computing device 112 to use in the real-time cryptocurrency-based payment, a network acknowledgment (ACK) of the receipt of the amount of the cryptocurrency is generated, the cryptocurrency is exchanged for the merchant's desired currency, and the merchant is paid. The ACK is pushed to the updated e-commerce platform device 132 at step 2. As compared to FIG. 10, the ACK of payment is sent to the updated e-commerce platform device 132 in FIG. 19 faster and through the use of less entities.

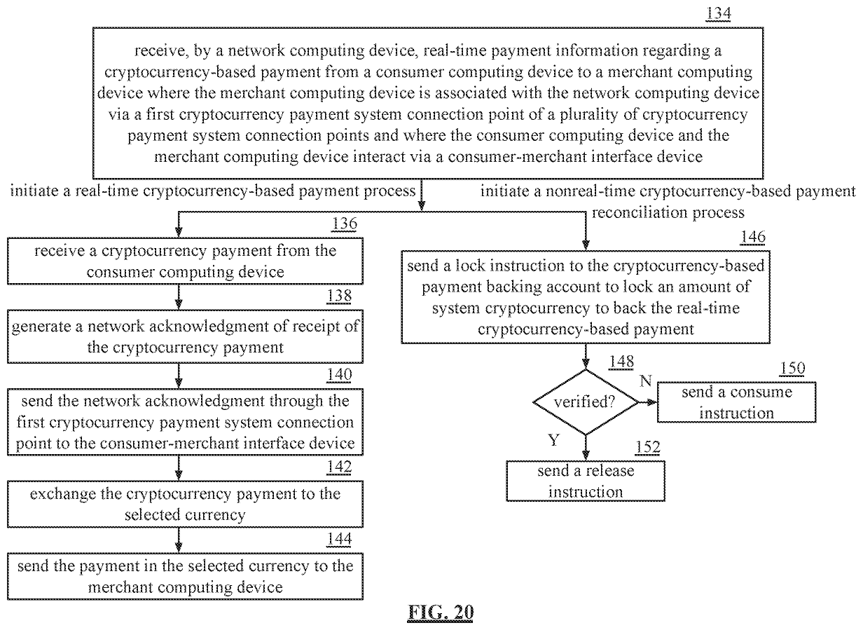

FIG. 20 is a flowchart of an example of a method of processing a cryptocurrency-based payment from a consumer computing device to a merchant computing device by a network computing device of the cryptocurrency payment system 10 of FIGS. 11-19. The method begins with step 134 where the network computing device receives real-time payment information regarding a cryptocurrency-based payment from a consumer computing device to a merchant computing device. The consumer computing device and the merchant computing device interact via a consumer-merchant interface device (e.g., a point-of-sale (POS) device, an e-commerce website, etc.).

For example, the consumer computing device sends consumer real-time payment information to the network computing device via a network application. The consumer real-time payment information includes a consumer identifier (ID) and a type of cryptocurrency it wishes to use in a real-time payment to the merchant computing device. The merchant computing device sends merchant real-time payment information to the network computing device via a first cryptocurrency payment system connection point of a plurality of cryptocurrency payment system connection points.

The plurality of cryptocurrency payment system connection points includes an updated point-of-sale (POS) device, an updated e-commerce platform, an updated merchant payment gateway, and an updated merchant payment processor. The plurality of cryptocurrency payment system connection points provide merchants options for how to connect to the cryptocurrency payment system based on what best suits a merchant's equipment needs, budget, and consumer interface requirements. As a specific example, the first cryptocurrency payment system connection point is an updated point-of-sale (POS) device that has software connecting it to the network computing device.

The merchant real-time payment information includes a merchant identifier (ID) and a type of selected currency (e.g., a fiat currency, another cryptocurrency, etc.) it wishes to receive in the real-time payment from the consumer computing device. One or more of the consumer real-time payment information and the merchant real-time payment information includes the amount of the real-time payment.

When the network computing device receives the real-time payment information, the network computing device initiates 1) a real-time cryptocurrency-based payment process and 2) a nonreal-time reconciliation process to reconcile the cryptocurrency-based payment with the cryptocurrency-based payment backing account device (e.g., the nonreal-time cryptocurrency-based payment reconciliation process). The reconciliation of the cryptocurrency-based payment with the cryptocurrency-based payment backing account device occurs within a time frame that is longer than the time frame of the real-time cryptocurrency-based payment.

The real-time cryptocurrency-based payment process includes steps 136-144 and the nonreal-time cryptocurrency-based payment reconciliation process includes steps 146-152. The real-time cryptocurrency-based payment process begins with step 136 where the network computing device receives a cryptocurrency payment from the consumer computing device to use in the real-time cryptocurrency-based payment.

The real-time cryptocurrency-based payment process continues with step 138 where the network computing device generates a network acknowledgment of receipt of the cryptocurrency payment from the consumer computing device. The real-time cryptocurrency-based payment process continues with step 140 where the network computing device sends the network acknowledgment through the first cryptocurrency payment system connection point to the consumer-merchant interface device. For example, the first cryptocurrency payment system connection point is an updated point-of-sale (POS) device or an updated e-commerce platform. In either case, those points are also the consumer-merchant interface devices such that the network acknowledgment passes from the network computing device directly to the consumer-merchant interface device.

In another example, the first cryptocurrency payment system connection point is an updated merchant payment gateway. In that example, the network acknowledgment passes from the network computing device to the updated merchant payment gateway and then to the consumer-merchant interface device. In another example, the first cryptocurrency payment system connection point is an updated merchant payment processor. In that example, the network acknowledgment passes from the network computing device to the updated merchant payment processor, to the updated merchant payment gateway, and then to the consumer-merchant interface device.

The real-time cryptocurrency-based payment process continues with step 142 where the network computing device exchanges the cryptocurrency payment received from the consumer computing device to a payment in the selected currency desired by the merchant computing device. The real-time cryptocurrency-based payment process continues with step 144 where the network computing device sends the payment in the selected currency to the merchant computing device.

Meanwhile, the nonreal-time cryptocurrency-based payment reconciliation process begins with step 146 where the network computing device instructs the cryptocurrency-based payment backing account device to lock an amount of system cryptocurrency associated with the real-time cryptocurrency-based payment. If the payment initiation is terminated (e.g., the payment is cancelled or fails within a certain amount of time prior to the network computing device continuing with the next steps of the real-time cryptocurrency-based payment loop), the network computing device sends a release instruction to the instructs the cryptocurrency-based payment backing account device to release the amount of system cryptocurrency.

The nonreal-time cryptocurrency-based payment reconciliation process continues with step 148 where the network computing device verifies the cryptocurrency payment received from the consumer computing device. For example, the network computing device connects to a consensus network that verifies the amount of the cryptocurrency received from the consumer computing device. The consensus network implements a verification process (e.g., such as a desired number of confirmations in a Bitcoin blockchain example) that may take minutes to hours of time.

When the network computing device verifies the cryptocurrency payment received by the consumer computing device, the method continues with step 152 where the network computing device instructs the cryptocurrency-based payment backing account device to release the amount of system cryptocurrency associated with the real-time cryptocurrency-based payment. When the network computing device does not verify the cryptocurrency payment received by the consumer computing device, the method continues to step 150 where the network computing device instructs the cryptocurrency-based payment backing account device to consume the amount of system cryptocurrency associated with the real-time cryptocurrency-based payment.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a network computing device of a cryptocurrency payment system, the method comprises:
receiving real-time payment information regarding a cryptocurrency-based payment from a source computing device to a destination computing device;
in response to receiving the real-time payment information:
initiating a real-time cryptocurrency-based payment process to pay the destination computing device in a selected currency, wherein payment of the selected currency to the destination computing device occurs within a first time frame; and
initiating a nonreal-time cryptocurrency-based payment reconciliation process to reconcile the cryptocurrency-based payment with a cryptocurrency-based payment backing account, wherein the reconciliation of the cryptocurrency-based payment with the cryptocurrency-based payment backing account occurs within a second time frame, and wherein the second time frame is longer than the first time frame.

2. The method of claim 1, wherein the real-time payment information includes:
source real-time payment information, wherein the source real-time payment information includes a source identifier (ID) and a type of cryptocurrency to use in the cryptocurrency-based payment;
destination real-time payment information, wherein the destination real-time payment information includes a destination identifier (ID) and the selected currency; and
an amount of the cryptocurrency-based payment.

3. The method of claim 2 further comprises:
receiving the source real-time payment information from the source computing device; and
receiving the destination real-time payment information and the amount of the cryptocurrency-based payment from one or more of: the source computing device and the destination computing device.

4. The method of claim 1, wherein the real-time cryptocurrency-based payment process comprises:
receiving an amount of cryptocurrency from the source computing device to use in the cryptocurrency-based payment;
generating a network acknowledgement of receipt of the amount of the cryptocurrency;
exchanging the amount of the cryptocurrency to an amount of the selected currency; and
sending the amount of the selected currency to the destination computing device.

5. The method of claim 4, wherein the nonreal-time cryptocurrency-based payment reconciliation process comprises:
locking an amount of system cryptocurrency stored in the cryptocurrency-based payment backing account based on the real-time payment information;
verifying the amount of cryptocurrency received from the source computing device using a nonreal-time verification process; and
when the amount of cryptocurrency is verified:
releasing the amount of the system cryptocurrency.

6. The method of claim 5 further comprises:
when the amount of cryptocurrency is not verified:
consuming the amount of the system cryptocurrency.

7. The method of claim 5 further comprises:
when the initiation of the real-time cryptocurrency-based payment process is terminated prior to paying the destination computing device in the selected currency:
releasing the amount of the system cryptocurrency.

8. The method of claim 1, wherein the first time frame is in seconds and the second time frame is in minutes.

9. A method comprises:
facilitating, by a network computing device of a cryptocurrency payment system, a real-time cryptocurrency-based payment from a source computing device paying with a cryptocurrency to a destination computing device accepting a desired currency, wherein the source computing device and the destination computing device interact via an interface means of the cryptocurrency payment system, wherein one or more of the source computing device and the destination computing device are associated with the network computing device via a network application, and wherein the network computing device facilitates the real-time cryptocurrency-based payment by:
receiving, by the network computing device, real-time payment information from at least the source computing device;
sending, by the network computing device, an instruction to a cryptocurrency-based payment backing account of the cryptocurrency payment system to lock an amount of system cryptocurrency-based on the real-time payment information; and
when an amount of cryptocurrency for the real-time cryptocurrency-based payment is received from the source computing device:
generating, by the network computing device, a network acknowledgement of receipt of the amount of the cryptocurrency;
exchanging, by the network computing device, the amount of the cryptocurrency to an amount of the desired currency; and
sending, by the network computing device, the amount of the desired currency to the destination computing device to complete the real-time cryptocurrency-based payment; and
reconciling, by the network computing device, the locked amount of system cryptocurrency by:
verifying, by the network computing device, the amount of cryptocurrency received from the source computing device for the real-time cryptocurrency-based payment using a nonreal-time verification process; and
when the amount of cryptocurrency is verified:
sending, by the network computing device, an instruction to the cryptocurrency-based payment backing account to release the locked amount of system cryptocurrency.

10. The method of claim 9 further comprises:
when the amount of cryptocurrency is not verified:
sending, by the network computing device, an instruction to the cryptocurrency-based payment backing account to consume the locked amount of system cryptocurrency.

11. The method of claim 9 further comprises:
when the real-time cryptocurrency-based payment is terminated prior to the sending the amount of the desired currency to the destination computing device:
sending, by the network computing device, an instruction to the cryptocurrency-based payment backing account to release the locked amount of system cryptocurrency.

12. The method of claim 9, wherein the interface means includes a direct link or a network connection.

13. The method of claim 9, wherein the real-time payment information includes:
source real-time payment information, wherein the source real-time payment information includes a source identifier (ID) and a type of cryptocurrency to use in the real-time cryptocurrency-based payment;
destination real-time payment information, wherein the destination real-time payment information includes a destination identifier (ID) and the desired currency for receiving the real-time cryptocurrency-based payment; and
an amount of the real-time cryptocurrency-based payment.

14. The method of claim 13 further comprises:
receiving, by the network computing device, the source real-time payment information from the source computing device; and
receiving, by the network computing device, the destination real-time payment information and the amount of the real-time cryptocurrency-based payment from one or more of the source computing device and the destination computing device.

15. The method of claim 13, wherein the cryptocurrency-based payment backing account is associated with the network computing device and one or more of: the source computing device, the destination computing device, or the type of cryptocurrency.

16. A computer readable memory comprises:
a first memory element that stores operational instructions that, when executed by a network computing device of a cryptocurrency payment system, causes the network computing device to:
receive real-time payment information regarding a cryptocurrency-based payment from a source computing device to a destination computing device; and
in response to receiving the real-time payment information:
a second memory element that stores operational instructions that, when executed by the network computing device, causes the network computing device to:
initiate a real-time cryptocurrency-based payment process to pay the destination computing device in a selected currency, wherein payment of the selected currency to the destination computing device occurs within a first time frame; and
a third memory element that stores operational instructions that, when executed by the network computing device, causes the network computing device to:
initiate a nonreal-time cryptocurrency-based payment reconciliation process to reconcile the cryptocurrency-based payment with a cryptocurrency-based payment backing account, wherein the reconciliation of the cryptocurrency-based payment with the cryptocurrency-based payment backing account occurs within a second time frame, and wherein the second time frame is longer than the first time frame.

17. The computer readable memory of claim 16, wherein the real-time payment information includes:
source real-time payment information, wherein the source real-time payment information includes a source identifier (ID) and a type of cryptocurrency to use in the cryptocurrency-based payment;
destination real-time payment information, wherein the destination real-time payment information includes a destination identifier (ID) and the selected currency; and
an amount of the cryptocurrency-based payment.

18. The computer readable memory of claim 17, wherein the first memory element further stores operational instructions that, when executed by the network computing device, causes the network computing device to:
receive the source real-time payment information from the source computing device; and
receive the destination real-time payment information and the amount of the cryptocurrency-based payment from one or more of: the source computing device and the destination computing device.

19. The computer readable memory of claim 16, wherein the second memory element further stores operational instructions that, when executed by the network computing device, causes the network computing device to execute the real-time cryptocurrency-based payment process by:
receiving an amount of cryptocurrency from the source computing device to use in the cryptocurrency-based payment;
generating a network acknowledgement of receipt of the amount of the cryptocurrency;
exchanging the amount of the cryptocurrency to an amount of the selected currency; and
sending the amount of the selected currency to the destination computing device.

20. The computer readable memory of claim 19, wherein the third memory element further stores operational instructions that, when executed by the network computing device, causes the network computing device to execute the nonreal-time cryptocurrency-based payment reconciliation process by:
locking an amount of system cryptocurrency stored in the cryptocurrency-based payment backing account based on the real-time payment information;
verifying the amount of cryptocurrency received from the source computing device using a nonreal-time verification process; and
when the amount of cryptocurrency is verified:
releasing the amount of the system cryptocurrency.

21. The computer readable memory of claim 20, wherein the third memory element further stores operational instructions that, when executed by the network computing device, causes the network computing device to:
when the amount of cryptocurrency is not verified:
consuming the amount of the system cryptocurrency.

22. The computer readable memory of claim 20, wherein the third memory element further stores operational instructions that, when executed by the network computing device, causes the network computing device to:
when the initiation of the real-time cryptocurrency-based payment process is terminated prior to paying the destination computing device in the selected currency:
releasing the amount of the system cryptocurrency.

23. The computer readable memory of claim 16, wherein the first time frame is in seconds and the second time frame is in minutes.
